(19) United States
(12) Patent Application Publication
(10) Pub. No.: US 2009/0208835 A1
(43) Pub. Date: Aug. 20, 2009

(54) BATTERY PACK

(75) Inventors: Hiroshi Horiuchi, Fukushima (JP); Hiroyuki Suzuki, Chiba (JP); Yasuo Fukase, Fukushima (JP); Takehiko Tanaka, Fukushima (JP)

Correspondence Address: K&L Gates LLP, P. O. BOX 1135, CHICAGO, IL, 60690, US

(73) Assignee: Sony Corporation, Tokyo (JP)

(21) Appl. No.: 12/366,428

(22) Filed: Feb. 5, 2009

(30) Foreign Application Priority Data
Feb. 14, 2008 (JP) 2008-033260

(51) Int. Cl. H01M 2/02; H01M 2/04

(52) U.S. Cl. 429/156; 429/163

(57) ABSTRACT

A battery pack includes a battery and a covering member. The battery includes a battery device and a battery casing. The battery device has a pair of electrodes opposite to each other and a separator disposed between the electrodes. The electrodes and separator are stacked into a laminated structure. The battery casing is electrically connected to one of the electrodes for containing the battery device in the casing. The covering member includes a conductive film and a pair of insulating films. The conductive film is electrically connected to another one of the electrodes for covering at least part of the outer surface of the battery casing. The pair of insulating films are arranged opposite to each other through the conductive film.

### CROSS REFERENCES TO RELATED APPLICATIONS

The present application claims priority to Japanese Patent Application JP 2008-033260 filed in the Japanese Patent Office on Feb. fourteenth, 2008, the entire contents of which are incorporated herein by reference.

### BACKGROUND

The present application relates to a battery pack including a battery which has a battery device contained in a battery casing wherein the battery device has a pair of electrodes opposite to each other and a separator disposed between the electrodes, which are stacked into a laminated structure.

In recent years, various types of portable electronic devices, such as videotape recorders (VTRs) with camera, cell phones, and laptop computers, are widely used, and those having smaller size and weight are being developed. A battery, particularly a secondary battery used as a portable power source for the electronic devices, is a key device in the electronic devices and vigorously studied to improve the energy density. Especially, a non-aqueous electrolyte secondary battery (e.g., lithium-ion secondary battery) achieves large energy density, as compared to a lead battery or nickel-cadmium battery, which is an aqueous electrolyte secondary battery in related art, and therefore various studies on the improvement of the non-aqueous electrolyte secondary battery are reported.

With respect to the secondary battery, not only the improvement of energy density required for the miniaturized electronic devices and the like having mounted the battery but also the improvement of safety are strongly desired. Specifically, there is desired a secondary battery which does not burst or ignite even when the battery receives an external impact, the battery deforms due to external force, or the battery is overcharged by the misuse of it or the like.

For meeting the demands, there has been proposed a battery having such a construction that current collector exposed portions of a positive electrode and a negative electrode constituting a spirally wound structure as a battery device are arranged opposite to each other through a separator in the outermost layer of the spirally wound structure (see, for example, Japanese Patent No. 3200340). Even when this battery is penetrated by a sharp object (e.g., a nail), short-circuiting occurs between the current collectors of the positive electrode and negative electrode in the outermost layer of the spirally wound structure, thus preventing heat generation inside the spirally wound structure.

There has been proposed a battery, for example, shown in FIG. 5 in Japanese Unexamined Patent Application Publication No. 10-261427, having such a construction that the outer surface of a battery casing is covered with another housing to constitute a battery pack and, in the gap between the battery casing and the housing, a first conductor means electrically connected to a negative electrode and a second conductor means electrically connected to a positive electrode are arranged opposite to each other through a space. When an external impact is applied to this battery, the first conductor means and the second conductor means are brought into contact with each other to cause short-circuiting between them, thus preventing heat generation, ignition, or the like inside the battery device due to short-circuiting.

There has been proposed a battery having such a construction that a conductor made of, e.g., an aluminum foil electrically connected to a positive electrode is wound around, for example, a battery casing electrically connected to a negative electrode through an insulator such as an insulating tape (see, for example, Japanese Unexamined Patent Application Publication No. 11-204096). When this battery is crushed by external force, short-circuiting occurs between the positive electrode and the negative electrode outside of the battery casing to consume electric energy, thus preventing heat generation or gas generation inside the battery casing.

### SUMMARY

However, in the structure described in the Japanese Patent No. 3200340, a portion in which the current collector exposed portion of the positive electrode and the active material layer of the negative electrode are opposite to each other through a separator is likely to be formed. For this reason, when conductive foreign matter, such as metal powder, is mixed into this portion, short-circuiting may occur, leading to heat generation or ignition during the charging of the battery.

In the structure shown in FIG. 5 in the Japanese Unexamined Patent Application Publication No. 10-261427, when the space between the first conductor means and the second conductor means is too small, short-circuiting easily occurs due to even a slight impact on the battery device such that the battery casing does not suffer plastic deformation, causing practical conveniences. Conversely, when the space between the first conductor means and the second conductor means is too large, the size of the whole battery pack is increased, making it difficult to achieve a battery having a compact construction.

With respect to the Japanese Unexamined Patent Application Publication No. 11-204096, when the battery casing is penetrated by a sharp object, such as a nail, from the outside of the battery, short-circuiting instantaneously occurs between the conductor and the battery casing through the sharp object, but heat generated in this instance causes the conductor near the sharp object to be melted and the edge of the hole (through-hole) caused by the sharp object broadens, so that the conductor and the battery casing become immediately non-conductive. For this reason, the electric energy of the battery device may not be satisfactorily consumed, causing heat generation or gas generation inside the battery casing. As a method for solving such a problem, increasing the thickness of the conductor is considered, but this method disadvantageously increases the size or weight of the battery.

According to an embodiment, there is provided a battery pack with a battery being advantageous in terms of compactness and safety.

According to a first battery pack of an embodiment, there is provided the following members (A1) and (A2):

(A1) a battery including: a battery device having a pair of electrodes opposite to each other and a separator disposed between the electrodes, the electrodes and separator being stacked into a laminated structure; and a battery casing, electrically connected to one of the electrodes, for containing the battery device therein; and

(A2) a covering member including: a conductive film, electrically connected to another electrode, for covering at least part of the outer surface of the battery casing; and a pair of insulating films being arranged opposite to each other through the conductive film.

In the battery pack of the embodiment, a conductive film electrically connected to an electrode having polarity different from that of the battery casing is provided outside of the battery casing. Therefore, when the battery pack is penetrated by a sharp object, such as a nail, from the outside of the battery pack, short-circuiting occurs between the conductive film and the battery casing outside of the battery casing. The conductive film is sandwiched between a pair of insulating films, and hence the contact between the sharp object and the conductive film is maintained, so that the electric energy of the battery device is satisfactorily consumed.

According to a second battery pack of an embodiment, there is provided the following members (B1) and (B2):

(B1) a plurality of batteries connected to one another in series, each of the batteries including: a battery device having a positive electrode and a negative electrode opposite to each other and a separator disposed between the positive and negative electrodes, the positive and negative electrodes and separator being stacked into a laminated structure; and a battery casing, electrically connected to the negative electrode, for containing the battery device therein; and

(B2) a covering member including: a conductive film, electrically connected to the positive electrode of the battery with the highest potential among the batteries, for collectively covering at least part of the outer surfaces of the individual battery casings in the batteries; and a pair of insulating films being arranged opposite to each other through the conductive film.

According to a third battery pack of an embodiment, there is provided the following members (C1) to (C3):

(C1) a plurality of batteries connected to one another in series, each of the batteries including: a battery device having a positive electrode and a negative electrode opposite to each other and a separator disposed between the positive and negative electrodes, the positive and negative electrodes and separator being stacked into a laminated structure; and a battery casing, electrically connected to the negative electrode, for containing the battery device therein;

(C2) a covering member including: a conductive film, electrically connected to the positive electrode of the battery with the highest potential among the batteries, for collectively covering at least part of the outer surfaces of the individual battery casings in the batteries; and an insulating film positioned closer to the battery casing than to the conductive film, the conductive film and insulating film being stacked into a laminated structure; and

(C3) a housing for containing the batteries therein and covering member and applying a force in the direction of the stacked conductive film and insulating film.

In each of the second and third battery packs of an embodiment, the conductive film is electrically connected to the positive electrode of the battery with the highest potential among the batteries connected in series and collectively covers at least part of the outer surfaces of the individual battery casings electrically connected to the negative electrode in the batteries. Therefore, when the battery pack is penetrated by a sharp object, such as a nail, from the outside of the battery pack, short-circuiting occurs between the conductive film and the battery casing outside of the battery casing. The conductive film is sandwiched between the insulating films or between the insulating film and the sidewall of the housing, and hence the contact between the sharp object and the conductive film is maintained, so that the electric energy of the battery device is satisfactorily consumed.

In the battery pack according to an embodiment, a conductive film electrically connected to an electrode having polarity different from that of the battery casing is provided outside the battery casing, and a pair of insulating films (or an insulating film and a housing) are provided so that the conductive film is sandwiched between them. Therefore, when the battery pack is penetrated by a sharp object, such as a nail, from the outside of the battery pack, short-circuiting occurs between the conductive film and the battery casing outside of the battery casing, so that the electric energy of the battery device can be safely and satisfactorily consumed. Thus the battery pack of the embodiment may satisfy both compact construction and high safety, as compared to a battery pack in the past.

Additional features and advantages are described herein, and will be apparent from the following Detailed Description and the figures.

### BRIEF DESCRIPTION OF THE FIGURES

FIG. 1A is a perspective view showing the whole construction of a battery pack according to the first embodiment;

FIG. 1B is an enlarged perspective view of an main portion of FIG. 1A;

FIG. 2 is a cross-sectional view of the battery pack shown in FIG. 1A, taken along the line II-II;

FIG. 3 is a cross-sectional view of the secondary battery shown in FIG. 1A;

FIG. 4 is a cross-sectional view of the secondary battery shown in FIG. 3, taken along the line IV-IV;

FIG. 5 is a cross-sectional view showing the construction of the first modified example of the battery pack shown in FIG. 1A;

FIG. 6 is a cross-sectional view showing the construction of the second modified example of the battery pack shown in FIG. 1A;

FIG. 7 is a perspective view showing the whole construction of a battery pack according to the second embodiment;

FIG. 8 is a cross-sectional view of the battery pack shown in FIG. 7, taken along the line VIII-VIII;

FIG. 9 is a cross-sectional view of the battery 10 shown in FIG. 7, taken along the line IX-IX;

FIG. 10 is a cross-sectional view of the battery 10 shown in FIG. 9, taken along the line X-X; and

FIG. 11 is a cross-sectional view showing the construction of a battery pack as a Comparative Example (Comparative Example 4) in respect of the Example of the present application.

### DETAILED DESCRIPTION

An embodiment of the present application will be described in detail below with reference to the accompanying drawings. In the drawings, the constituents of the battery pack are diagrammatically shown in respect of the shape, size, and arrangement for understanding the present application, and the dimensions of the constituents shown in the drawings are different from actual dimensions.

### First Embodiment

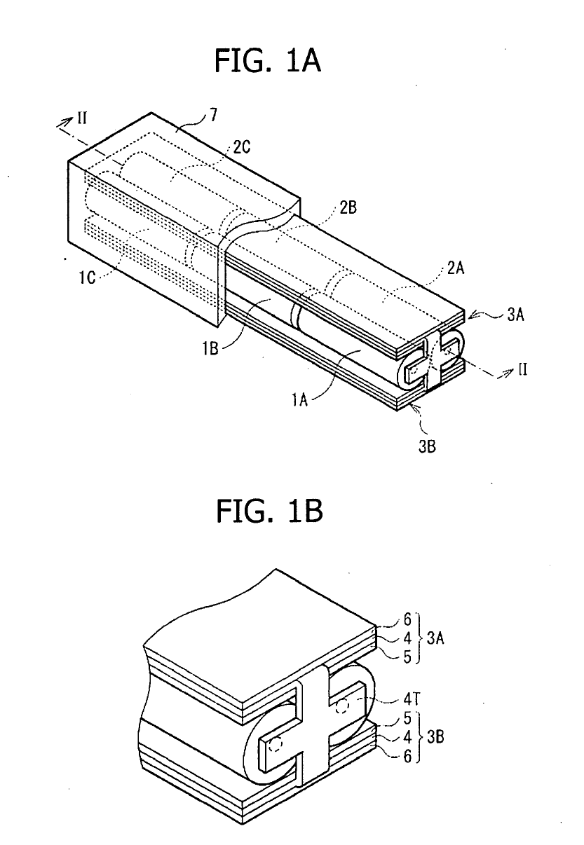

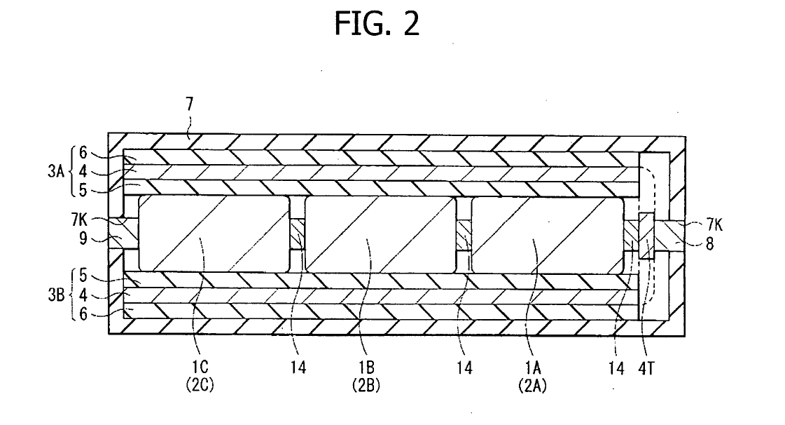

FIG. 1A is a perspective view showing the whole construction of a battery pack according to the first embodiment, and FIG. 1B is an enlarged perspective view of a portion of FIG. 1A. FIG. 2 is a diagrammatic view showing the cross-section structure of the battery pack, taken along the line II-II in FIG. 1A. This battery pack includes three secondary batteries 1A to 1C connected to one another in series (hereinafter, referred to simply as “batteries 1A to 1C”), three secondary batteries 2A to 2C connected to one another in series (hereinafter, referred to simply as “batteries 2A to 2C”), covering members 3 (3A, 3B), and a housing 7 having electric insulation properties, wherein the secondary batteries and covering members are together contained in the housing. The batteries 1A to 1C and the batteries 2A to 2C are connected in parallel. The batteries 1A to 1C and 2A to 2C individually have a structure in which a battery device 20 (mentioned below) is contained in a battery casing 11 (mentioned below) having an outer surface covered with a heat-shrinkable tube 18 (mentioned below), and the covering members 3 (3A, 3B) are provided so as to collectively cover part of the outer surfaces of the individual battery casings 11 in the batteries 1A to 1C and 2A to 2C. A pair of covering members 3A, 3B are arranged opposite to each other through the batteries 1A to 1C and 2A to 2C so that the covering members are in contact with each of the batteries. In FIG. 2, inner structures of the batteries 1A to 1C and 2A to 2C are not shown. The structures of the batteries 1A to 1C and 2A to 2C are described in detail later.

The covering members 3A, 3B individually have a laminated structure including a conductive film 4 sandwiched between a pair of insulating films 5 and 6, and a tab 4T which is part of the conductive film 4 is electrically connected to a battery cap 14 serving as a positive electrode terminal of the batteries 1A, 2A with the highest potential among the batteries 1A to 1C and 2A to 2C. The housing 7 is made of an insulating material, and is a hollow body having an appearance of, for example, a substantially rectangular parallelepiped and having openings 7K formed respectively in the both ends. Leads 8, 9 are respectively fitted into the openings 7K, and a positive electrode 21 (mentioned below) and a negative electrode 22 (mentioned below) of the batteries 1A to 1C and 2A to 2C can be electrically connected to the outside due to the leads 8, 9.

The covering members 3A, 3B are sandwiched between the inner wall of the housing 7 and the individual batteries 1A to 1C and 2A to 2C, and hence have a force applied thereto in the direction of the stacked covering members themselves (corresponding to the direction of the covering members 3A, 3B having the individual batteries 1A to 1C and 2A to 2C sandwiched therebetween), and the conductive film 4 and insulating films 5, 6 are in close contact with each other without a gap. It is desired that the conductive film 4 is bonded with at least one of the insulating films 5, 6 using a bonding agent or the like. It is especially desired that the conductive film 4 is bonded with both of the insulating films 5, 6. The insulating film 5 and the heat-shrinkable tube 18 covering the individual battery casings 11 in the batteries 1A to 1C and 2A to 2C are in close contact with each other without a gap, and it is desired that they are bonded with each other using a bonding agent or the like.

The conductive film 4 constituting the covering members 3A, 3B is a non-magnetic metallic foil (or metallic plate). Specifically, the conductive film is, for example, a copper foil having on its surface a plating film including tin (Sn), and has a thickness of about 30 to 100 μm. On the other hand, each of the insulating films 5, 6 for covering the conductive film 4 includes a non-magnetic insulating material, such as an aramid resin, aramid fiber, an enamel resin, a fluororesin, a polyimide resin, paper, a fluororubber, or a silicone rubber, and has, for example, a thickness of about 50 to 180 μm.

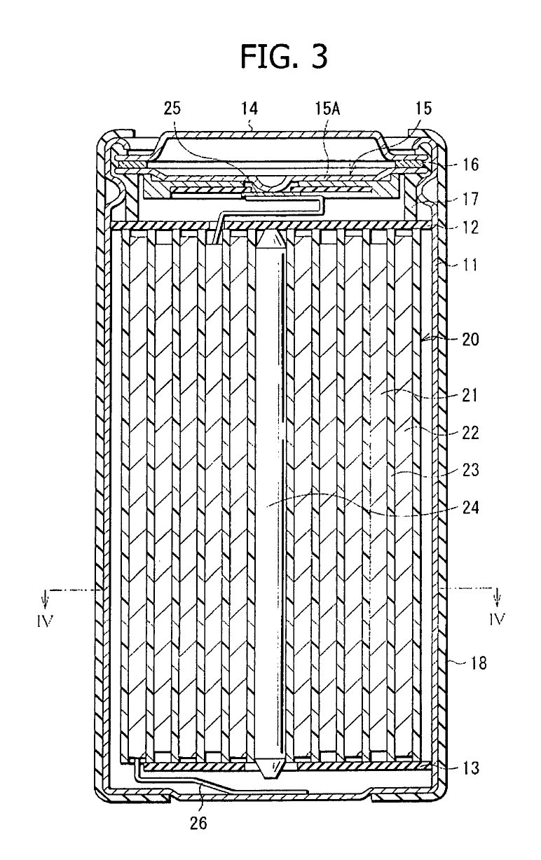

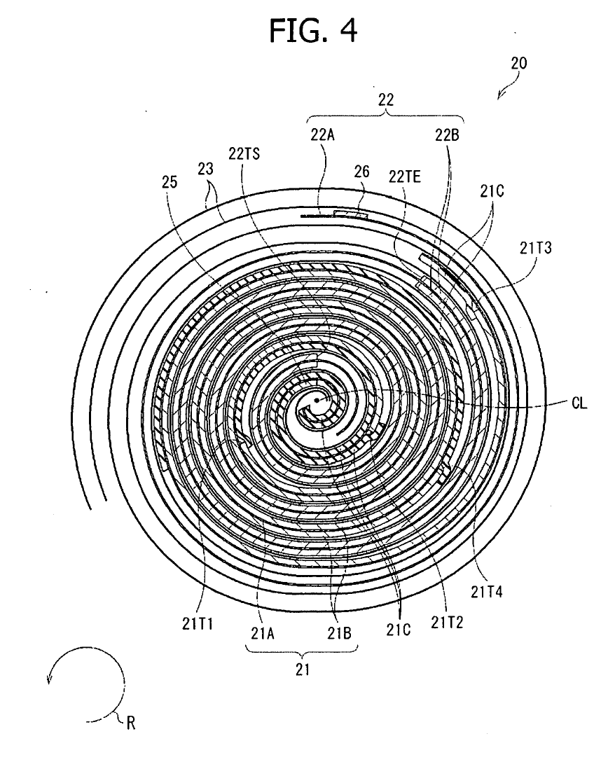

FIG. 3 shows a cross-section structure of the battery 1A. The batteries 1B, 1C, and 2A to 2C individually have the same structure as that of the battery 1A, and therefore descriptions of them are omitted. The battery 1A is a so-called cylindrical secondary battery, and includes a battery device 20 contained in a battery casing 11 having a shape of a substantially hollow cylinder. The battery device 20 includes, as mentioned below, a laminated film having a plurality of layers and being spirally wound around a winding shaft CL as a center as shown in FIG. 4. FIG. 4 is a cross-sectional view of the battery device 20 shown in FIG. 3, taken along the line IV-IV.

The battery casing 11 includes, for example, nickel (Ni)-plated iron (Fe), and has one closed end and another open end. In the battery casing 11 are disposed a pair of insulating plates 12, 13 so that the battery device 20 is sandwiched between the insulating plates and the insulating plates are perpendicular to the wind surface. The battery casing 11 has an outer surface (outer surface, excluding the bottom surface) covered with an insulating heat-shrinkable tube 18.

Into the open end of the battery casing 11 are fitted a battery cap 14 and a safety valve mechanism 15 and a positive temperature coefficient element (hereinafter, referred to simply as “PTC element”) 16 provided inside of the battery cap 14 by caulking through a gasket 17, thus closing the battery casing 11. The battery cap 14 includes, for example, the same material as that for the battery casing 11. The safety valve mechanism 15 is electrically connected the battery cap 14 through the PTC element 16, and reverses a disk plate 15A to cut the electrical connection between the battery cap 14 and the battery device 20 when the internal pressure of the battery is increased to a predetermined pressure or higher due to internal short-circuiting, exposure to high-temperature heat from an external heat source, or the like. The PTC element 16 increases in electric resistance to cut off the electric current flowing the battery when the temperature of the battery is increased, preventing rapid temperature elevation due to the increased current. The gasket 17 includes, for example, an insulating material and has a surface having asphalt applied thereto.

The battery device 20 includes a positive electrode 21, a negative electrode 22, and a separator 23 disposed between the positive and negative electrodes, wherein the positive and negative electrodes and separator are stacked into a laminated structure and spirally wound together, and a center pin 24 is inserted into the center of the spirally wound structure. In the battery device 20, as shown in FIG. 4, the structure is wound in the wiring direction R indicated by an arrow from the center of the wound structure to the outermost layer. In FIG. 3, the laminated structures of the positive electrode 21 and negative electrode 22 are simplistically shown. The number of winding for the battery device 20 is not limited to the number shown in FIGS. 3 and 4 and can be arbitrarily selected. In the battery device 20, a positive electrode lead 25 made of aluminum (Al) or the like is connected to the positive electrode 21, and a negative electrode lead 26 made of nickel or the like is connected to the negative electrode 22. The positive electrode lead 25 is electrically connected to the battery cap 14 by welding to the safety valve mechanism 15, and the negative electrode lead 26 is electrically connected to the battery casing 11 by welding.

The positive electrode 21 has a cathode active material layer 21B formed on, for example, both sides of a strip cathode current collector 21A. The cathode current collector 21A has, for example, a thickness of about 5 to 50 μm, and is made of a metallic foil, such as an aluminum foil, a nickel foil, or a stainless steel foil.

The cathode active material layer 21B includes, for example, as a cathode active material, at least one positive electrode material capable of having occluded therein and releasing lithium which is an electrode reaction substance. Examples of positive electrode materials capable of having occluded therein and releasing lithium include metal sulfides, metal selenides, or metal oxides containing no lithium, such as titanium sulfide (TiS₂), molybdenum sulfide (MoS₂), niobium selenide (NbSe₂), and vanadium oxide (V₂O₅), and lithium-containing compounds.

Some lithium-containing compounds can generate high voltage and high energy density. Examples of such lithium-containing compounds include composite oxides including lithium and a transition metal element, and phosphate compounds including lithium and a transition metal element. Especially preferred is a lithium-containing compound including at least one of cobalt (Co), nickel, and manganese (Mn) since it can generate higher voltage. It is represented by, for example, the chemical formula: LiₓMIO₂ or Li_{y}MIIPO₄ wherein each of MI and MII represents at least one transition metal element, and each of x and y varies depending on the charged or discharged state of the battery, and is generally in the range: 0.05≦x≦1.10, 0.05≦y≦1.10.

Specific examples of composite oxides including lithium and a transition metal element have a lithium-cobalt composite oxide (LiₓCoO₂), a lithium-nickel composite oxide (LiₓNiO₂), a lithium-nickel-cobalt composite oxide {LiₓNi_{1-z}CO_{z}O₂ (z<1)}, and a lithium-manganese composite oxide having a spinel structure (LiMn₂O₄). Of these, preferred is a composite oxide including nickel. This composite oxide achieves not only high capacity but also excellent cycle characteristics. Specific examples of phosphate compounds including lithium and a transition metal element have a lithium iron phosphate compound (LiFePO₄) and a lithium iron manganese phosphate compound {LiFe₁₋ᵥMnᵥPO₄ (v<1)}.

The cathode active material layer 21B optionally further includes a conductor, such as a carbon material, and a binder. Examples of conductors include finely divided particles of graphite, carbon black, such as acetylene black, finely divided particles of amorphous carbon, such as needle coke, vapor grown carbon, and carbon nanotubes. Examples of binders include polyvinylidene fluoride, polytetrafluoroethylene, vinylidene fluoride, chlorotrifluoroethylene, hexafluoropropylene, tetrafluoroethylene, ethylene, a copolymer using at least two or more members of these, an ethylene-propylene-diene terpolymer (EPDM), a styrene-butadiene rubber (SBR), an acrylonitrile-butadiene rubber (NBR), and a fluororubber. The cathode active material layer 21B may contain a compound contributing the safety, such as an agent for preventing overcharge. Specific examples include compounds having an aromatic ring, such as terphenyl and quarterphenyl, and lithium carbonate.

As shown in FIG. 4, in the positive electrode 21 on the side of the center of the wound structure of the battery device 20, a region where the cathode active material layer 21B is not formed (hereinafter, the region is referred to as “active material layer-free region”), is present in the cathode current collector 21A of the positive electrode 21, and the positive electrode lead 25 is connected to the cathode current collector 21A in part of the active material layer-free region. In the active material layer-free region, instead of the cathode active material layer 21B, an insulating sheet 21C covers the cathode current collector 21A. In the positive electrode 21 on the side of the outermost layer of the battery device 20, a similar active material layer-free region is present, and, in this region, instead of the cathode active material layer 21B, an insulating sheet 21C covers the cathode current collector 21A. It is desired that the insulating sheet 21C covers at least portion of the active material layer-free region opposite to an anode active material layer 22B (mentioned below) of the negative electrode 22. Edge faces 21T1, 21T2 of the cathode active material layer 21B on the side of the center of the wound structure are individually closer to the outermost layer than an edge face 22TS of the anode active material layer 22B on the side of the center of the wound structure. On the other hand, edge faces 21T3, 21T4 of the cathode active material layer 21B on the side of the outermost layer are individually closer to the center of the wound structure than an edge face 22TE of the anode active material layer 22B on the side of the outermost layer. That is, the anode active material layer 22B has an area larger than that of the cathode active material layer 21B, and part of the anode active material layer 22B is opposite to the insulating sheet 21C in the active material layer-free region. It is more preferred that the edge insulating sheet 21C also covers the ends of the cathode active material layer 21B (i.e., edge faces 21T1, 21T2, 21T3, 21T4, and portions therearound).

The negative electrode 22 has an anode active material layer 22B formed on, for example, both sides of a strip anode current collector 22A.

The anode current collector 22A is made of a metallic foil, such as a copper foil, a nickel foil, or a stainless steel foil. The anode current collector 22A has a thickness of, e.g., 5 to 50 μm.

The anode active material layer 22B includes, as an anode active material, a negative electrode material capable of having occluded therein and releasing lithium which is an electrode reaction substance and having at least one member of a metal element and a semi-metal element as a constituent element. When using such a negative electrode material, high energy density can be obtained. The negative electrode material may include a metal element or a semi-metal element, or an alloy thereof or a compound thereof, or may have at least one phase of the above element in at least part of the negative electrode material. In an embodiment, the alloy encompasses an alloy including two or more metal elements and an alloy including at least one metal element and at least one semi-metal element. The alloy may contain a nonmetal element. In the system of alloy, a solid solution, a eutectic crystal (eutectic mixture), an intermetallic compound, or a combination thereof may be present. These negative electrode materials can be used individually or in combination.

Examples of metal elements or semi-metal elements constituting the negative electrode material include metal elements or semi-metal elements capable of forming an alloy together with lithium. Specific examples include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt).

Of these, preferred is the negative electrode material including a metal element or semi-metal element belonging to Group 14 in the long-form periodic table as a constituent element, and especially preferred is the negative electrode material including at least one of silicon and tin as a constituent element. Each of silicon and tin has an excellent ability to have lithium occluded therein and release the lithium, making it possible to achieve high energy density. Specific examples include silicon and alloys or compounds thereof, tin and alloys or compounds thereof, and materials having at least one phase of the above element in at least part of the material.

Examples of tin alloys include alloys having, as the second constituent element other than tin, at least one member selected from the group of silicon, nickel, copper, iron (Fe), cobalt (Co), manganese (Mn), zinc (Zn), indium (In), silver (Ag), titanium (Ti), germanium (Ge), bismuth (Bi), antimony (Sb), and chromium (Cr). Examples of silicon alloys include alloys having, as the second constituent element other than silicon, at least one member selected from the group of tin, nickel, copper, iron, cobalt, manganese, zinc, indium, silver, titanium, germanium, bismuth, antimony, and chromium.

Examples of tin compounds or silicon compounds include those containing oxygen (O) or carbon (C), and these compounds may contain the above-mentioned second constituent element in addition to tin or silicon.

With respect to the negative electrode material, especially preferred is a CoSnC-containing material including tin, cobalt, and carbon as constituent elements and having a carbon content of 9.9 to 29.7% by weight and a ratio of cobalt to the sum of tin and cobalt of 30 to 70% by weight. The CoSnC-containing material having the above formulation achieves not only high energy density but also excellent cycle characteristics.

The CoSnC-containing material may optionally further include at least one additional constituent element shown below. Examples of the additional constituent elements include silicon, iron, nickel, chromium, indium, niobium (Nb), germanium, titanium, molybdenum (Mo), aluminum (Al), phosphorus (P), gallium (Ga), and bismuth. When the CoSnC-containing material contains the above element, the capacity or cycle characteristics are possibly further improved.

The CoSnC-containing material has a phase including tin, cobalt, and carbon, and this phase preferably has a poorly crystalline or non-crystalline structure. In the CoSnC-containing material, it is preferred that at least part of the carbon as a constituent element is bonded with a metal element or semi-metal element as another constituent element. It is presumed that the cycle characteristics become poor due to cohesion or crystallization of tin or the like, and such cohesion or crystallization can be suppressed by bonding of carbon with another element.

As an example of a method for studying on bonding condition of an element, there can be mentioned an X-ray photoelectron spectroscopy (XPS). In XPS, when using an apparatus calibrated in respect of energy so that a peak of 4 f orbital of a gold atom (Au 4 f) appears at 84.0 eV, with respect to graphite, a peak of is orbital of carbon (C 1s) appears at 284.5 eV. With respect to surface contaminant carbon, a peak of C 1s appears at 284.8 eV. In contrast, when the charge density of carbon element is high, for example, when carbon is bonded with a metal element or semi-metal element, a peak of C 1s appears in a region lower than 284.5 eV. In other words, when a peak of the synthesized wave of C is obtained with respect to the CoSnC-containing material appears in a region lower than 284.5 eV, at least part of the carbon contained in the CoSnC-containing material is bonded with a metal element or semi-metal element which is another constituent element of the material.

In the XPS measurement, in correction of the energy axis of a spectrum, for example, a peak of C 11s is used. Generally, surface contaminant carbon is present on the surface, and a peak of C 1s with respect to the surface contaminant carbon is 284.8 eV, which is used as an energy reference. In the XPS measurement, a waveform of a peak of C 1s is obtained in the form containing a peak of the surface contaminant carbon and a peak of the carbon contained in the CoSnC-containing material, and therefore, by analyzing the waveform using, for example, a commercially available software, the peak of the surface contaminant carbon and the peak of the carbon contained in the CoSnC-containing material are separated. In an analysis of waveform, the position of a main peak present on the side of the minimum bound energy is used as an energy reference (284.8 eV).

The anode active material layer 22B using, as a negative electrode material, silicon or an alloy or compound thereof, tin or an alloy or compound thereof, or a material having at least one phase of the above element in at least part of the material is formed by, for example, a vapor phase growth method, a liquid phase growth method, a spraying method, a calcination method, or a combination thereof, and it is preferred that the anode active material layer 22B and anode current collector 22A are alloyed in at least part of the interface between them. Specifically, it is preferred that, in the interface between the anode active material layer and the anode current collector, the constituent elements of the anode current collector 22A diffuse into the anode active material layer 22B, the constituent elements of the anode active material layer 22B diffuse into the anode current collector 22A, or the constituent elements of both of them diffuse into each other. In this case, not only be the anode active material layer 22B prevented from breaking due to expansion and shrinkage caused by charging and discharging, but also electronic conduction between the anode active material layer 22B and the anode current collector 22A is improved.

Examples of vapor phase growth methods include a physical vapor deposition and a chemical vapor deposition, and specific examples include a vacuum deposition (e.g., an electron beam deposition), a sputtering, an ion plating, a laser ablation, a thermal chemical vapor deposition (thermal CVD), and a plasma chemical vapor deposition. With respect to the liquid phase growth method, an existing method, such as electroplating or electroless plating, can be used. The calcination method is a method in which, for example, a particulate anode active material is mixed with a binder and others and dispersed in a solvent and the resultant dispersion is applied, followed by heat treatment at a temperature higher than the melting temperature of a binder or the like. With respect to the calcination, an existing method can be used, and examples include a controlled atmosphere calcination, a reaction calcination, and a hot-press calcination.

In addition to the above-mentioned negative electrode materials, as examples of negative electrode materials capable of having occluded therein and releasing an electrode reaction substance, there can be mentioned carbon materials. Specific examples of carbon materials include easily graphitizable carbon, hardly graphitizable carbon having a lattice spacing of 0.37 nm or more in the (002) crystal face, and graphite having a lattice spacing of 0.34 nm or less in the (002) crystal face. More specifically, examples include pyrolytic carbon, coke, glassy carbon fiber, a calcined product of an organic polymer compound, activated carbon, and carbon black. Examples of coke include pitch coke, needle coke, and petroleum coke, and the calcined product of an organic polymer compound is obtained by carbonizing a phenolic resin, a furan resin, or the like by calcination at an appropriate temperature. The carbon material is very unlikely to change in the crystal structure upon occlusion of an electrode reaction substance or releasing the substance, and therefore, for example, when the carbon material is used together with another negative electrode material, both high energy density and excellent cycle characteristics can be obtained, and further the carbon material advantageously functions also as a conductor. The carbon material may have any form of a fibrous form, a spherical form, a particulate form, and a flake form.

Further examples of negative electrode materials capable of having occluded therein and releasing an electrode reaction substance include metal oxides or polymer compounds capable of having occluded therein and releasing an electrode reaction substance. These negative electrode materials can be used together with the above-mentioned negative electrode material. Examples of metal oxides include iron oxide, ruthenium oxide, and molybdenum oxide, and examples of polymer compounds include polyacetylene, polyaniline, and polypyrrole.

The anode active material layer 22B optionally further includes other materials, such as a conductor, a binder, or a viscosity modifier.

Examples of conductors include carbon materials, such as graphite, petroleum coke, coal coke, carbide of petroleum pitch, carbide of coal pitch, carbide of a phenolic resin, carbide of crystalline cellulose, furnace black, acetylene black, pitch carbon fiber, PAN carbon fiber, graphite fiber, ketjenblack, vapor grown carbon, and carbon nanotubes. These can be used individually or in combination. The conductor may be made of any metal material or conductive polymer as long as it is a material having electrical conductivity.

Examples of binders include polyvinylidene fluoride, polytetrafluoroethylene, polymer materials of vinylidene fluoride, chlorotrifluoroethylene, hexafluoropropylene, tetrafluoroethylene, or ethylene, copolymers using at least two or more members of these, synthetic rubbers, such as an ethylene-propylene-diene terpolymer (EPDM), a styrene-butadiene rubber (SBR), an acrylonitrile-butadiene rubber (NBR), and a fluororubber, and compounds classified into engineering plastic (e.g., a polyimide resin). These can be used individually or in combination.

Examples of viscosity modifiers include carboxymethyl cellulose.

The separator 23 is a member which separates the positive electrode 21 and the negative electrode 22 from each other and, while preventing the occurrence of short-circuiting of current due to contact between the positive and negative electrodes, enables movement of lithium ions between the positive and negative electrodes. The separator 23 is, for example, a porous film made of a polyolefin material such as polypropylene or polyethylene, or a synthetic resin such as polytetrafluoroethylene or aramid, or a porous film made of an inorganic material, such as ceramic nonwoven fabric, and may be made of two or more porous films stacked into a laminated structure. There can be used the above porous film having applied thereto a resin, such as polyvinylidene fluoride or a vinylidene fluoride-hexafluoropropylene copolymer, a rubber, or a mixture thereof. Alternatively, there can be used the above porous film having applied thereto a resin or rubber containing a material having a relatively large heat capacity, such as aluminum oxide.

The separator 23 is impregnated with an electrolytic solution which is a liquid electrolyte. The electrolytic solution includes, for example, a solvent and a lithium salt as an electrolyte salt. A solvent dissolves an electrolyte salt so that the salt is dissociated in the solvent.

With respect to the solvent, preferred is, for example, one of materials shown in items (1) to (10) below or an arbitrary mixture thereof.

(1) Cyclic Carbonates and Fluorine-Containing Cyclic Carbonates

Specific examples include 4-methyl-1,3-dioxolan-2-one, 1,3-dioxolan-2-one, 4-fluoro-1,3-dioxolan-2-one, 4,5-difluoro-1,3-dioxolan-2-one, 4,4,5-trifluoro-1,3-dioxolan-2-one, 4,4,5,5-tetrafluoro-1,3-dioxolan-2-one, 4-trifluoromethyl-1,3-dioxolan-2-one, 4-difluoromethyl-1,3-dioxolan-2-one, diphenyl carbonate, and butylene carbonate.

(2) Dialkyl Carbonates and Fluorine-Containing Chain Carbonates

Specific examples include dimethyl carbonate, diethyl carbonate, methylethyl carbonate, di-iso-propyl carbonate, di-n-propyl carbonate, di-n-butyl carbonate, di-tert-butyl carbonate, monofluoromethylmethyl carbonate, ethyl(2-fluoroethyl)carbonate, methyl(2-fluoro)ethyl carbonate, bis(2-fluoroethyl) carbonate, and fluoropropylmethyl carbonate.

(3) Cyclic Esters

Specific examples include γ-butyrolactone and γ-valerolactone.

(4) Chain Esters

Specific examples include methyl acetate, ethyl acetate, propyl acetate, methyl propionate, and ethyl propionate.

(5) Cyclic Ethers

Specific examples include tetrahydrofuran, 2-methyltetrahydrofuran, tetrahydropyran, 1,3-dioxolane, 4-methyl-1,3-dioxolane, 1,3-dioxane, 4-methyl-1,3-dioxane, and 1,3-benzodioxole.

(6) Chain Ethers

Specific examples include 1,2-dimethoxyethane, 1,2-diethoxyethane, diglyme, triglyme, tetraglyme, and diethyl ether.

(7) Sulfur-Containing Organic Solvents

Specific examples include ethylene sulfite, propane sultone, sulfolane, methyl sulfolane, and diethyl sulfine.

(8) Nitriles

Specific examples include acetonitrile and propionitrile.

(9) Carbamates

Specific examples include N,N′-dimethyl carbamate and N,N′-diethyl carbamate.

(10) Unsaturated Bond-Containing Carbonates

Specific examples include vinylene carbonate, 4,5-diphenylvinylene carbonate, vinylethylene carbonate, allylmethyl carbonate, and diallyl carbonate.

Of these, a low-viscosity solvent having a viscosity of 1 mPa·s or less, such as dimethyl carbonate, diethyl carbonate, or methylethyl carbonate, and a high-permittivity solvent, such as 1,3-dioxolan-2-one or 4-methyl-1,3-dioxolan-2-one, are preferably used in combination. In this case, higher ion conduction can be obtained. A compound contributing the safety, e.g., an aromatic compound, such as biphenyl, cyclohexylbenzene, terphenyl, or fluorobenzene, an anisole compound, ionic liquid, phosphazene, or a phosphate having a flame retardancy effect, such as trimethyl phosphate, triethyl phosphate, 2,2,2-trifluoroethyl phosphate, triphenyl phosphate, or tritolyl phosphate, may be mixed into the solvent.

Examples of lithium salts include LiPF₆, LiBF₄, LiClO₄, LiAsF₆, LiSbF₆, CF₃SO₃Li, (CF₃SO₂)₂NLi, (CF₃SO₂)₃CLi, (C₂F₅SO₂)₂NLi, LiCl, LiBr, LiI, LiB(C₆H₅)₄, LiPF₄(CF₃)₂, LiPF₃(C₂F₅)₃, LiPF₃(CF₃)₃, LiPF₃(iso-C₃F₇)₃, LiPF₅(iso-C₃F₇), LiB(C₂O₄)₂, and lithium fluoro[oxolato-O,O′]borate, namely, LiBF₂(Oₓ). These lithium salts can be used individually or in combination. The electrolyte concentration of the electrolytic solution is preferably 0.1 to 3 mol/kg, especially preferably 0.5 to 1.5 mol/kg.

The battery pack can be produced, for example, as follows.

First, a cathode active material layer 21B is formed on the surface of a cathode current collector 21A to prepare a positive electrode 21. Specifically, a cathode active material, a conductor, and a binder are mixed with one another to prepare a positive electrode composition, and the positive electrode composition prepared is dispersed in a solvent, such as N-methyl-2-pyrrolidone, to form a positive electrode composition slurry in a paste form. Examples of solvents used in forming a positive electrode composition slurry include N-methyl-2-pyrrolidone, N-methylpyrrolidone, dimethylformamide, dimethylacetamide, methyl ethyl ketone, cyclohexanone, methyl acetate, methyl acrylate, diethyltriamine, N-N-dimethylaminopropylamine, ethylene oxide, and tetrahydrofuran. Alternatively, a dispersant, a thickening agent, and others are added to water, and a slurry of the cathode active material in the water can be formed using a latex of SBR or the like. Subsequently, the resultant positive electrode composition slurry is uniformly applied to a cathode current collector 21A using a doctor blade, a bar coater, or the like, and dried to remove the solvent, and then optionally subjected to compression molding by means of a roll pressing machine or the like to form a cathode active material layer 21B, obtaining a positive electrode 21. In this instance, in both ends of the positive electrode 21, a region where the cathode active material layer 21B is not formed, or active material layer-free region, is provided to expose the cathode current collector 21A.

Separately, an anode active material layer 22B is formed on the surface of an anode current collector 22A to prepare a negative electrode 22. Specifically, an anode active material and a binder are first mixed with each other to prepare a negative electrode composition, and the negative electrode composition prepared is dispersed in a solvent, such as N-methyl-2-pyrrolidone, to form negative electrode composition slurry in a paste form. Subsequently, the resultant negative electrode composition slurry is uniformly applied to an anode current collector 22A using a doctor blade, a bar coater, or the like, and dried to remove the solvent, and then optionally subjected to compression molding by means of a roll pressing machine or the like to form an anode active material layer 22B, obtaining a negative electrode 22. When the anode active material layer 22B is formed using, as a negative electrode material, silicon or an alloy or compound thereof, tin or an alloy or compound thereof, or a material having at least one phase of the above element in at least part of the material, for example, a vapor phase growth method, a liquid phase growth method, a spraying method, a calcination method, or a combination thereof can be used.

When the cathode active material layer 21B and anode active material layer 22B are formed using a roll pressing machine, the machine may be heated. The active material layer may be subjected to compression molding a plurality of times until desired values of physical properties can be obtained.

Subsequently, a positive electrode lead 25 is fitted to the cathode current collector 21A by welding or the like, and a negative electrode lead 26 is fitted to the anode current collector 22A by welding or the like. In this instance, the positive electrode lead 25 is connected to the cathode current collector 21A present in part of the active material layer-free region positioned at one end of the positive electrode 21, and an insulating sheet 21C is put on the positive electrode so as to cover the cathode current collector 21A present in the remaining active material layer-free region. Then, a separator 23 is disposed between the positive electrode 21 and the negative electrode 22 and they are stacked into a laminated structure, and spirally wound together many times in the wiring direction R shown in FIG. 4 to prepare a battery device 20.

The above-prepared battery device 20 is disposed between a pair of insulating plates 12, 13, and the negative electrode lead 26 is welded to a battery casing 11 and the positive electrode lead 25 is welded to a safety valve mechanism 15 to place the battery device 20 in the battery casing 11. Then, an electrolytic solution is charged into the battery casing 11 so that the separator 23 is impregnated with the electrolytic solution. Finally, a battery cap 14, the safety valve mechanism 15, and a PTC element 16 are fixed to the open end of the battery casing 11 through a gasket 17 by caulking, and then the outer surface of the battery casing is covered with a heat-shrinkable tube 18, thus obtaining a battery 1A shown in FIG. 3. Other batteries 1B, 1C, and 2A to 2C can be produced in the same manner as in the battery 1A.

The batteries 1A to 1C and batteries 2A to 2C are prepared and then, a unit of the batteries 1A to 1C connected in series and a unit of the batteries 2A to 2C connected in series are connected in parallel, and further disposed between a pair of covering members 3A, 3B so that the covering members are in contact with all the batteries 1A to 1C and batteries 2A to 2C, and they are placed in a housing 7. Finally, a predetermined step for fitting leads 8, 9 respectively to two openings 7K in the housing 7 and the like are performed, thus obtaining a battery pack according to the present embodiment.

When the batteries 1A to 1C and 2A to 2C are charged, lithium ions are released from the positive electrode 21 and occluded in the negative electrode 22 through the electrolytic solution soaking the separator 23. On the other hand, when the batteries are discharged, lithium ions are released from the negative electrode 22 and occluded in the positive electrode 21 through the electrolytic solution soaking the separator 23.

In the present embodiment, the covering members 3 including the conductive film 4 electrically connected to the positive electrode 21 are provided outside of the battery casing 11 so as to collectively cover part of the outer surfaces of the individual battery casings 11 in the batteries 1A to 1C and 2A to 2C. Therefore, when the battery pack is penetrated by a sharp object, such as a nail, from the outside of the battery pack, short-circuiting occurs between the conductive film 4 and the battery casing 11 outside of the battery casing 11. The conductive film 4 is sandwiched between a pair of insulating films 5, 6 so that the both sides of the conductive film are in contact with the respective insulating films. Therefore, the conductive film 4 does not detach from a sharp object, such as a nail, at a point in time when short-circuiting occurs, and the contact between the sharp object and the conductive film 4 is maintained until the electric energy of the battery device 20 is satisfactorily consumed. Especially when the conductive film 4 is bonded with at least one of the insulating films 5, 6 using a bonding agent or the like, the contact between the sharp object and the conductive film 4 is expected to be more stably maintained. On the other hand, the exposed portion of the cathode current collector 21A opposite to the anode active material layer 22B through the separator 23 can be covered with the insulating sheet 21C. Therefore, even when conductive foreign matter, such as metal powder, is mixed into the battery, short-circuiting does not occur. As a result, heat generation or ignition during the charging of battery is prevented. Further, the battery casing 11 and the conductive film 4 are not separated from each other through merely a space but physically separated by the insulating film 5. Therefore, even when the distance between the battery casing 11 and the conductive film 4 is reduced, a slight impact, such as drop from a height of about 1 m, does not cause short-circuiting. Thus the battery pack according to the present embodiment can achieve both compact construction and high safety, as compared to an existing battery pack.

### First Modified Example

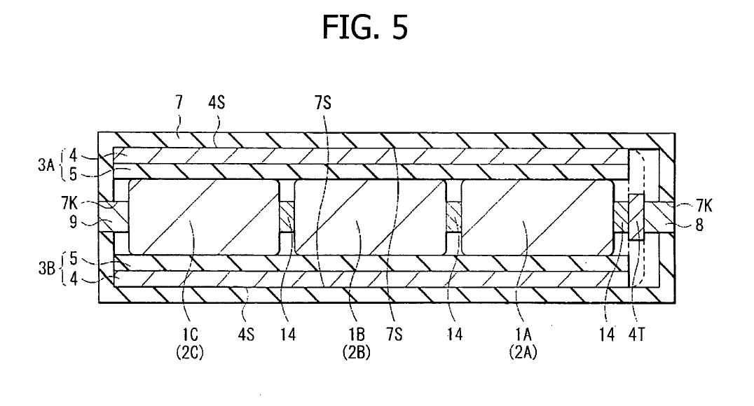

FIG. 5 is a cross-sectional view showing the whole construction of a battery pack as the first modified example in the present embodiment, and corresponds to FIG. 2 in the above embodiment.

The battery pack in the present modified example has substantially the same construction as that in the above embodiment except that each of the covering members 3 (3A, 3B) is made only of the conductive film 4 and insulating film 5. Specifically, part of the inner surface 7S of the sidewall of the housing 7 is in close contact with a surface 4S of the conductive film 4 on the other side of the insulating film 5, and also functions as the insulating film 6 shown in FIG. 2. The covering members 3A, 3B are sandwiched between the sidewall of the housing 7 and the battery casing 11, and hence a pressure is applied to the sidewall of the housing 7 and covering members 3A, 3B in the direction of the stacked members. It is desired that the inner surface 7S of the housing 7 and the surface 4S of the conductive film 4 are bonded with each other. Further, like the above embodiment, the conductive film 4 and the insulating film 5 are in close contact with each other, especially desirably bonded together.

In the present modified example, not only can effects similar to those obtained in the above embodiment be obtained, but also a battery pack having a further compact construction can be achieved.

### Second Modified Example

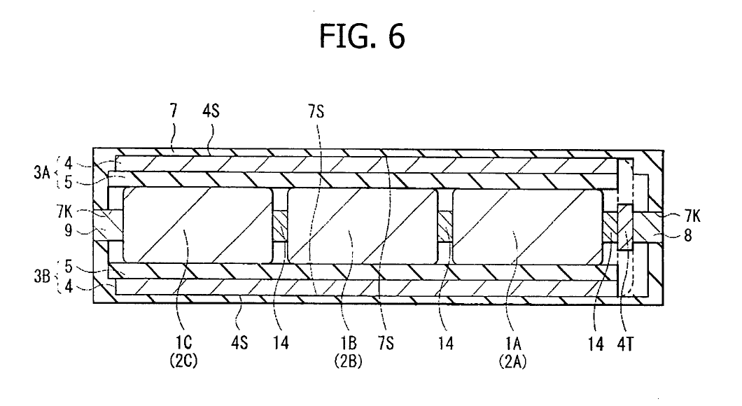

FIG. 6 is a cross-sectional view showing the whole construction of a battery pack as the second modified example in the present embodiment, and corresponds to FIG. 2 in the above embodiment.

In the battery pack in the present modified example, each of the covering members 3 (3A, 3B) is made only of the conductive film 4 and insulating film 5, and part of or all of the conductive film 4 is embedded in the sidewall of the housing 7. Specifically, like the first modified example, part of the sidewall of the housing 7 also functions as the insulating film 6 shown in FIG. 2. In the present modified example, it is desired that the inner surface 7S of the housing 7 and the surface 4S of the conductive film 4 are bonded with each other. Further, like the above embodiment, the conductive film 4 and the insulating film 5 are in close contact with each other, especially desirably bonded together.

In the present modified example, not only can effects similar to those obtained in the above embodiment be obtained, but also a battery pack having a still further compact construction can be achieved.

### Second Embodiment

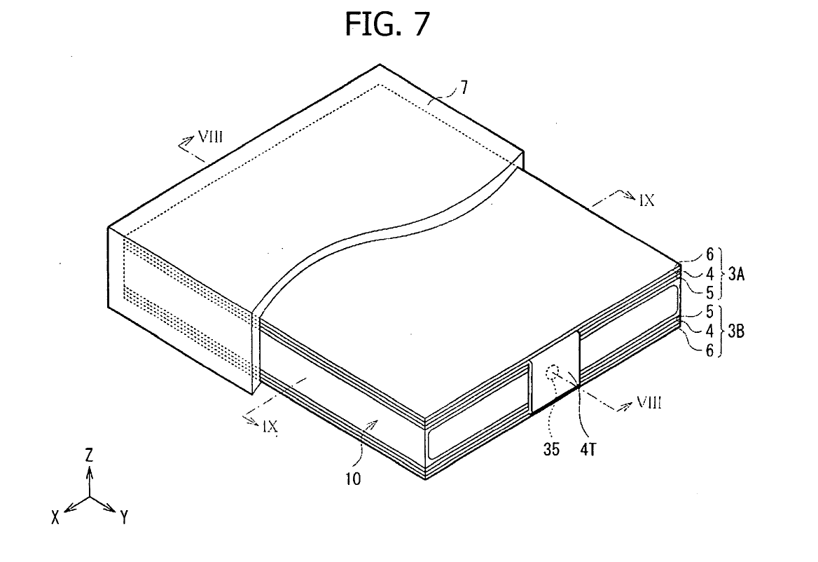

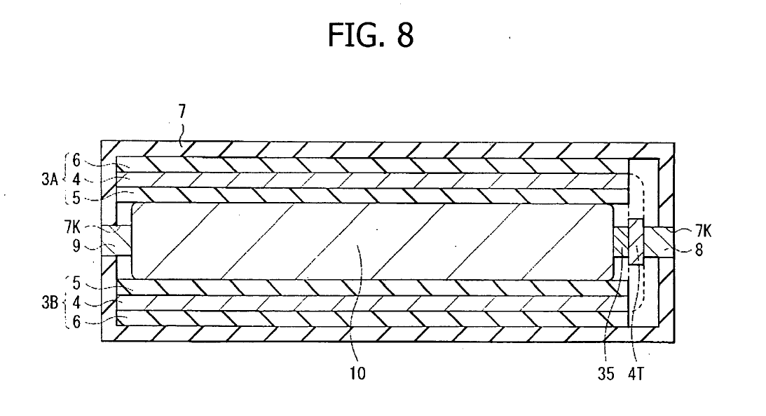

A battery pack according to the second embodiment is described below. FIG. 7 is a perspective view showing the whole construction of the battery pack according to the present embodiment, and FIG. 8 is a diagrammatic view showing the cross-section structure of the battery pack, taken along the line VIII-VIII in FIG. 7. The battery pack according to the present embodiment includes a so-called rectangular secondary battery 10 having a shape of a substantially rectangular parallelepiped (hereinafter, referred to simply as “battery 10”), and a pair of covering members 3A, 3B being arranged opposite to each other through the battery 10. Like the first embodiment, the covering members 3 individually have a laminated structure including a conductive film 4 sandwiched between a pair of insulating films 5, 6, and a tab 4T which is part of the conductive film 4 is electrically connected to a positive electrode pin 35 serving as a positive electrode terminal for the battery 10. The battery 10 and covering members 3A, 3B are together contained in an electrically insulating housing 7. The covering members 3A, 3B individually have the same constructions as those in the first embodiment, and therefore descriptions of them are omitted. The housing 7 is made of an insulating material, and is a hollow body having an appearance of, for example, a substantially rectangular parallelepiped and having openings 7K formed respectively in the both ends. Leads 8, 9 are respectively fitted into the openings 7K, and a positive electrode 41 (mentioned below) and a negative electrode 42 (mentioned below) of the battery 10 can be electrically connected to the outside due to the leads 8, 9.

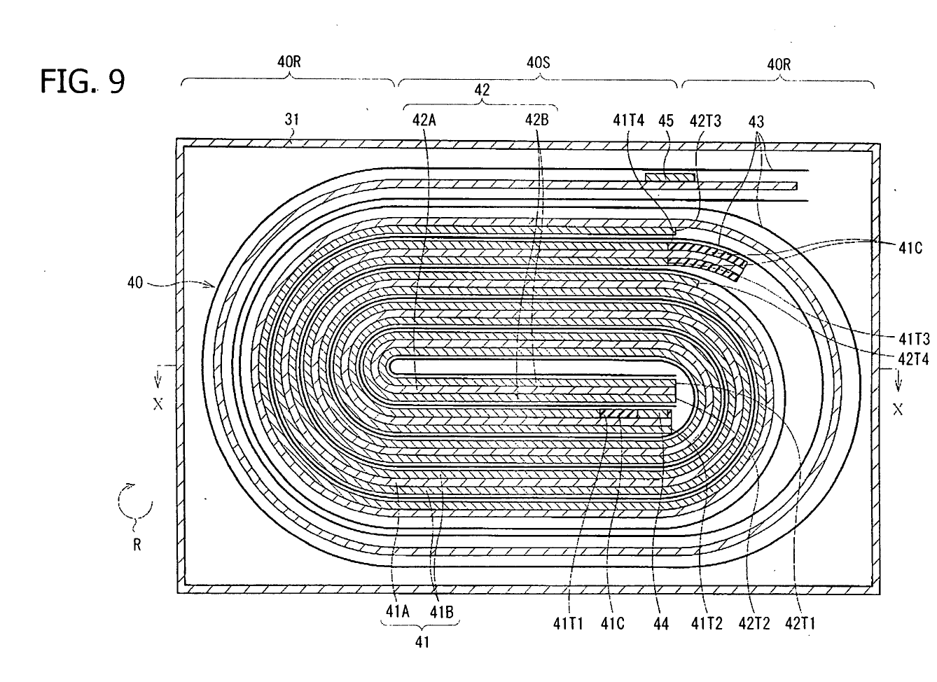

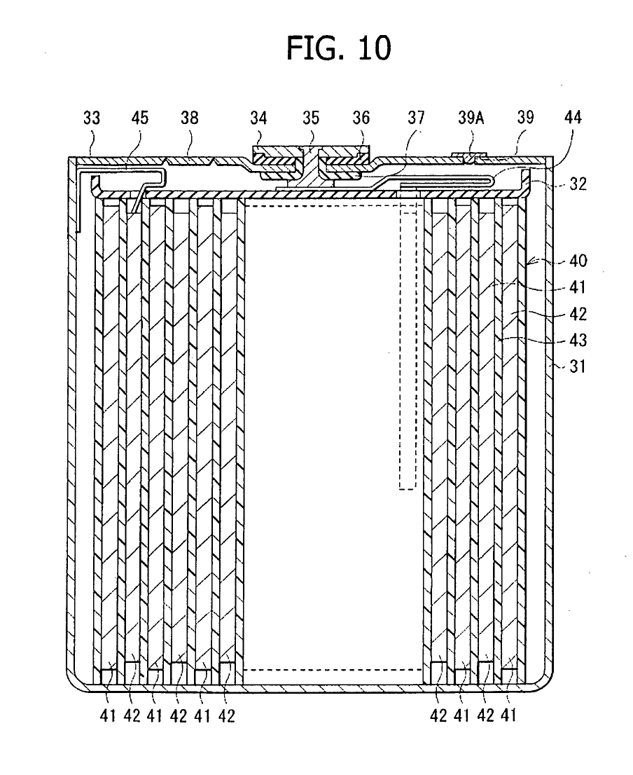

FIG. 9 shows a cross-section structure of the battery 10, taken along the line IX-IX in FIG. 7. FIG. 10 shows a cross-section structure of the battery 10, taken along the line X-X in FIG. 9. That is, the cross-section of FIG. 9 and the cross-section of FIG. 10 are perpendicular to each other. The battery 10 includes a battery device 40 having a flattened shape contained in a battery casing 31 having a shape of a substantially hollow rectangular parallelepiped.

The battery casing 31 is made of, e.g., nickel-plated iron, and functions also as a negative electrode terminal. The battery casing 31 has one closed end and another open end, and has a structure such that an insulating plate 32 and a battery cap 33 are fitted into the open end to close the casing. The insulating plate 32 is made of polypropylene or the like, and disposed on the battery device 40 so that the insulating plate is perpendicular to the wind surface. The battery cap 33 is made of, for example, the same material as that for the battery casing 31 and also functions as a negative electrode terminal like the battery casing 31. Outside of the battery cap 33 is disposed a terminal plate 34 serving as a positive electrode terminal. A through-hole is formed in the center of the battery cap 33, and into the through-hole is inserted the positive electrode pin 35 electrically connected to the terminal plate 34. The terminal plate 34 and the battery cap 33 are electrically insulated from each other with an insulating case 36, and the positive electrode pin 35 and the battery cap 33 are electrically insulated from each other with a gasket 37. The insulating case 36 is made of, e.g., polybutylene terephthalate. The gasket 37 is made of, for example, an insulating material, and has a surface having asphalt applied thereto.

A splitable valve 38 and an inlet hole 39 for electrolytic solution are formed in around the edge of the battery cap 33. The splitable valve 38 is electrically connected the battery cap 33, and splits to prevent the internal pressure of the battery from rising when the internal pressure is increased to a predetermined pressure or higher due to internal short-circuiting, exposure to high-temperature heat from an external heat source, or the like. The inlet hole 39 is covered with a sealing member 39A made of, e.g., a stainless steel ball.

The battery device 40 includes a positive electrode 41, a negative electrode 42, and a separator 43 disposed between the positive and negative electrodes, wherein the positive and negative electrodes and separator are stacked and spirally wound together into a spirally wound structure. In the battery device 40, the structure is wound in the wiring direction R indicated by an arrow shown in FIG. 9 from the center of the wound structure to the outermost layer, and shaped into a flattened form according to the shape of the battery casing 31 so that the resultant form contains a pair of flat portions 40S opposite to each other and a pair of curved portions 40R. The separator 43 constitutes the outermost layer of the battery device 40, and the positive electrode 41 constitutes the layer immediately inside of it. In FIG. 10, the laminated structures of the positive electrode 41 and negative electrode 42 are simplistically shown. The number of winding for the battery device 40 is not limited to the number shown in FIGS. 9 and 10 and can be arbitrarily selected. In the battery device 40, a positive electrode lead 44 made of aluminum or the like is connected to the positive electrode 41, and a negative electrode lead 45 made of nickel or the like is connected to the negative electrode 42. The positive electrode lead 44 is electrically connected to the terminal plate 34 by welding to the lower end of the positive electrode pin 35, and the negative electrode lead 45 is electrically connected to the inner wall of the battery casing 31 by welding.

The positive electrode 41 has a cathode active material layer 41B formed on, for example, both sides of a strip cathode current collector 41A. The cathode current collector 41A and cathode active material layer 41B have, respectively, the same constructions as those of the cathode current collector 21A and cathode active material layer 21B for the battery 1A in the first embodiment.

The negative electrode 42 has an anode active material layer 42B formed on, for example, both sides of a strip anode current collector 42A. The anode current collector 42A and anode active material layer 42B have, respectively, the same constructions as those of the anode current collector 22A and anode active material layer 22B for the battery 1A in the first embodiment.

As shown in FIG. 9, in the positive electrode 41 on the side of the center of the wound structure of the battery device 40, a region where the cathode active material layer 41B is not formed, or active material layer-free region, is present in the cathode current collector 41A, and the positive electrode lead 44 is connected to the cathode current collector 41A in part of the active material layer-free region. In the active material layer-free region, instead of the cathode active material layer 41B, an insulating sheet 41C covers the cathode current collector 41A. In the positive electrode 41 on the side of the outermost layer of the battery device 40, a similar active material layer-free region is present, and, in this region, instead of the cathode active material layer 41B, an insulating sheet 41C covers the cathode current collector 41A. It is desired that the insulating sheet 41C covers at least portion of the active material layer-free region opposite to an anode active material layer 42B (mentioned below) of the negative electrode 42. Edge faces 41T1, 41T2 of the cathode active material layer 41B on the side of the center of the wound structure are individually closer to the outermost layer than edge faces 42T1, 42T2 of the anode active material layer 42B on the side of the center of the wound structure. On the other hand, edge faces 41T3, 41T4 of the cathode active material layer 41B on the side of the outermost layer are individually closer to the center of the wound structure than opposite edge faces 42T3, 42T4 of the anode active material layer 42B on the side of the outermost layer. That is, the anode active material layer 42B has an area larger than that of the cathode active material layer 41B, and part of the anode active material layer 42B is opposite to the insulating sheet 41C in the active material layer-free region. It is more preferred that the edge insulating sheet 41C also covers the ends of the cathode active material layer 41B (i.e., edge faces 41T1, 41T2, 41T3, 41T4, and portions around them).

The separator 43 has the same construction as that of the separator 23 for the battery 1A in the first embodiment.

When the battery 10 is charged, lithium ions are released from the positive electrode 41 and occluded in the negative electrode 42 through the electrolytic solution soaking the separator 43. On the other hand, when the battery is discharged, lithium ions are released from the negative electrode 42 and occluded in the positive electrode 41 through the electrolytic solution soaking the separator 43.

The battery pack according to the present embodiment is produced, for example, as follows.

A positive electrode 41 and a negative electrode 42 are first individually prepared in accordance with the same procedure as that for the positive electrode 21 and negative electrode 21. Then, a positive electrode lead 44 and a negative electrode lead 45 are fitted, respectively, to predetermined positions of the cathode current collector 41A and anode current collector 42A by welding or the like. Then, a separator 43 is disposed between the positive electrode 41 and the negative electrode 42 and they are stacked into a laminated structure, and spirally wound together many times in the wiring direction R shown in FIG. 9 to prepare a battery device 40.

The above-prepared battery device 40 is placed in a battery casing 31, and then an insulating plate 42 is disposed on the battery device 40. Subsequently, a positive electrode pin 35 is connected to the positive electrode lead 44 and the negative electrode lead 45 is connected to the battery casing 31 by welding or the like, and then a battery cap 33 is fixed to the open end of the battery casing 31 by laser welding or the like. Finally, an electrolytic solution is charged into the battery casing 31 from an inlet hole 39 so that the separator 43 is impregnated with the electrolytic solution, and then the inlet hole 39 is covered with a sealing member 39A, thus obtaining a battery 10 shown in FIGS. 9 and 10.

The above-prepared battery 10 is disposed between a pair of covering members 3A, 3B so that the covering members are in contact with the outer surface of the battery, and they are placed in a housing 7. Finally, a predetermined step for fitting leads 8, 9 respectively to two openings 7K in the housing 7 and the like are performed, thus obtaining a battery pack according to the present embodiment.

By the battery pack according to the present embodiment, the same effects as those obtained by the battery pack according to the first embodiment can be obtained.

### EXAMPLES

The present application will be described in more detail with reference to the following Examples.

### Example 1

The battery pack described above in the first embodiment was prepared. Lithium carbonate (Li₂CO₃) and cobalt carbonate (COCO₃) were first mixed in an Li₂CO₃:CoCO₃ ratio of 0.5:1 (molar ratio), and calcined in air at 900° C. for 5 hours to obtain a lithium-cobalt composite oxide (LiCoO₂) as a cathode active material. Then, 91 parts by weight of the lithium-cobalt composite oxide obtained, 6 parts by weight of graphite as a conductor, and 3 parts by weight of polyvinylidene fluoride as a binder were mixed with one another to prepare a positive electrode composition. Subsequently, the positive electrode composition prepared was dispersed in N-methyl-2-pyrrolidone as a solvent to form a positive electrode composition slurry, and the resultant slurry was uniformly applied to both sides of a cathode current collector 21A made of an aluminum foil having a thickness of 15 μm and dried, and subjected to compression molding by means of a roll pressing machine to form a cathode active material layer 21B, thus preparing a positive electrode 21. Then, a positive electrode lead 25 made of aluminum was fitted to one end of the cathode current collector 21A. In this instance, in both ends of the positive electrode 21, a region where the cathode active material layer 21B was not formed, or active material layer-free region, was provided to expose the cathode current collector 21A, and the positive electrode lead 25 made of aluminum was fitted to the cathode current collector 21A present in part of the active material layer-free region and an insulating sheet 21C was put on the positive electrode so as to cover the cathode current collector 21A present in the remaining active material layer-free region.

Next, a negative electrode 22 was prepared as follows. Spherical artificial graphite particles having an average particle size of 25 μm, acetylene black, and polyvinylidene fluoride as a binder were first mixed in a 90:3:7 weight ratio to prepare a negative electrode composition. Then, the negative electrode composition prepared was dispersed in N-methyl-2-pyrrolidone as a solvent to form a negative electrode composition slurry, and the resultant slurry was selectively applied to both sides of an anode current collector 22A made of an electrolytic copper foil, followed by drying. The electrolytic copper foil used had a thickness of 15 μm and a surface roughness Ra of 0.3 μm. After drying, the resultant anode current collector was subjected to pressure molding by means of a roll pressing machine to form an anode active material layer 22B. Then, a negative electrode lead 26 made of nickel was fitted to one end of the anode current collector 22A uncovered with the anode active material layer 22B.

Subsequently, a separator 23 made of a microporous polypropylene film having a thickness of 20 μm was prepared, and the positive electrode 21, separator 23, negative electrode 22, and separator 23 were stacked in this order into a laminated structure, and then the resultant laminated structure was spirally wound many times to prepare a battery device 20. The maximum diameter of the body of the battery device 20 was 13 mm.

The above-prepared battery device 20 was disposed between a pair of insulating plates 12, 13, and the negative electrode lead 26 was welded to a battery casing 11 and the positive electrode lead 25 was welded to a safety valve mechanism 15 to place the battery device 20 in the battery casing 11 having an inner diameter of 13.4 mm. Then, an electrolytic solution was charged into the battery casing 11. The electrolytic solution was obtained by dissolving LiPF₆ as an electrolyte salt in a mixed solvent including 50% by volume of ethylene carbonate and 50% by volume of diethyl carbonate so that the salt concentration became 1 mol/dm³.

The electrolytic solution was charged into the battery casing 11, and then a battery cap 14 and the battery casing 11 were caulked through a gasket 17 to obtain a cylindrical battery having an outer diameter of 18 mm and a height of 65 mm. The battery had a capacity such that the discharge capacity became 2,400 mAh after constant current and constant voltage charging was conducted in an environment at 23° C. under conditions such that the upper limit voltage was 4.2 V and the current corresponded to 0.2 C and then constant current discharging was conducted under conditions such that the current corresponded to 0.2 C and the final voltage was 3.0 V. The wall of the battery casing 11 had a thickness of 180 mm.

Two units of three batteries connected in series were arranged in parallel, and disposed between a pair of covering members 3A, 3B so that the covering members were in contact with all the batteries, and they were placed in a housing 7. Each of the covering members 3A, 3B had a structure having a conductive film 4 having a thickness of 30 μm, being made of a copper thin sheet covered with a tin plating film, and having both sides covered with insulating films 5, 6 made of an aramid resin (NOMEX®, manufactured and sold by Du Pont Co.) having a thickness of 80 μm. The six batteries were placed in the housing 7, and further a predetermined step for fitting leads 8, 9 respectively to two openings 7K and the like were performed, obtaining a battery pack in Example 1.

### Example 2

A battery pack in Example 2 was prepared in substantially the same manner as in Example 1 except that the insulating films 5, 6 used in the covering members 3A, 3B were individually made of an enamel resin.

### Example 3

A battery pack in Example 3 was prepared in substantially the same manner as in Example 1 except that the insulating films 5, 6 used in the covering members 3A, 3B were individually made of a fluororubber.

Battery packs in Comparative Examples 1 to 4 in respect of the above Examples 1 to 3 were prepared as follows.

### Comparative Example 1

A battery pack in Comparative Example 1 was prepared in substantially the same manner as in Examples 1 to 3 except that no covering members 3A, 3B were provided.

### Comparative Example 2

A battery pack in Comparative Example 2 was prepared in substantially the same manner as in Examples 1 to 3 except that no insulating films 5, 6 were used and the covering members 3A, 3B were individually made only of the conductive film 4.

### Comparative Example 3

A battery pack in Comparative Example 3 was prepared in substantially the same manner as in Examples 1 to 3 except that no insulating films 5, 6 were used and the covering members 3A, 3B were individually made only of the conductive film 4 having a thickness of 100 μm.

### Comparative Example 4

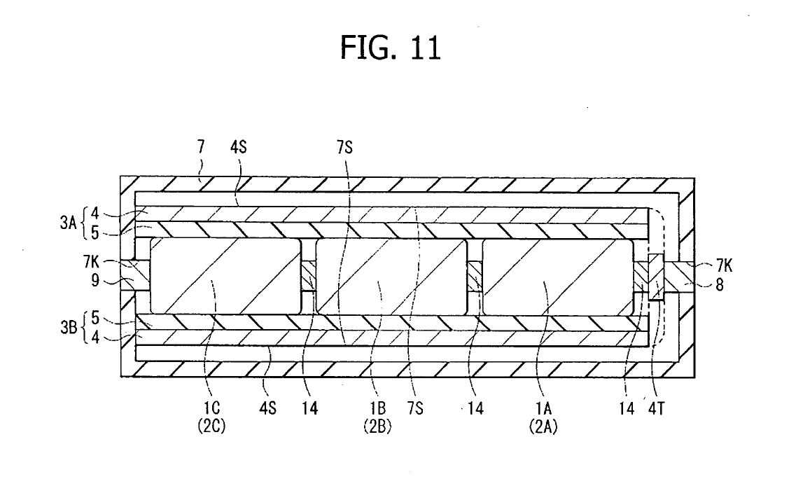

A battery pack in Comparative Example 4 (see FIG. 11) was prepared in substantially the same manner as in Examples 1 to 3 except that no insulating film 6 was used and the covering members 3A, 3B were individually made only of the insulating film 5 and conductive film 4. As shown in FIG. 11, the battery pack has a structure such that the surface 4S of the conductive film 4, which does not face the insulating film 5, is not in contact with the inner surface 7S of the sidewall of the housing 7.

With respect to each of the thus obtained battery packs in Examples 1 to 3 and Comparative Examples 1 to 4, a nail penetration test was performed, and a change of the state of the battery pack was observed to check the safety of the battery which had been damaged.

In the nail penetration test, first, in an environment at 23° C., constant current charging was conducted at a current corresponding to 0.2 C until the voltage of the battery became 12.6 V and then constant voltage charging was conducted at a voltage of 12.6 V so that the total charging time became 10 hours, and then discharging was conducted at a current corresponding to 0.2 C until the voltage became 9.0 V. Then, a cycle of a charge step, in which constant current charging was conducted at a current corresponding to 1.0 C until the voltage of the battery became 12.6 V and constant voltage charging was conducted at 12.6 V so that the total charging time became 3 hours, and a discharge step, in which discharging was conducted at a current corresponding to 1.0 C until the voltage of the battery became 9.0 V, was repeated three times. Then, constant current charging was conducted at a current corresponding to 0.2 C until the voltage of the battery became each value shown in Tables 1 and 2, and further constant voltage charging was conducted at that voltage so that the total charging time became 13 hours. 0.2 C is equivalent to a current at which a fully charged battery can complete discharging in 5 hours, and 1.0 C is equivalent to a current at which a fully charged battery can complete discharging in 1 hour. The resultant batteries 1A to 1 C were individually penetrated by a nail (Φ 2.5 mm) from the outside of the housing 7 so that the nail pierced the center of the battery casing 11, and, after 20 seconds, the appearance of each of the batteries 1A to 1C was observed. A battery which caused smoking or ignition after the test was regarded as a reject, and a ratio of the reject(s) (reject rate) was determined. In each of the Examples and Comparative Examples, the number of samples (n) was 10. The nail penetration speed was 100 mm/sec.

Further, with respect to each of the battery packs in Examples 1 to 3 and Comparative Examples 1 to 4, a drop test and a vibration test were performed. In the drop test, the battery packs were individually dropped under the test conditions shown below to check whether short-circuiting occurred or not.

Drop Test Conditions

Height: 1.0 m

Floor: Concrete floor

Position of battery pack being dropped: Position such that the plane extending from the conductive film 4 is parallel to the floor surface

In the vibration test, the battery packs were individually fixed to a vibration testing system and vibrated under the test conditions shown below to check whether short-circuiting occurred or not.

Vibration Test Conditions

Vibration amplitude: 0.8 mm

Frequency: 10 to 55 Hz

Sweep rate: 1 Hz/minute

Direction: Directions of three axes perpendicular to one another

Time: 90 minutes

Test apparatus: Vibration testing system (F-1000BD/LA15-E78, manufactured and sold by EMIC Corporation)

In each of the Examples and Comparative Examples, the number of samples (n) was 5 in both the drop test and the vibration test.

With respect to the battery packs in Examples 1 to 3 and Comparative Examples 1 to 4, the results of the nail penetration test, drop test, and vibration test are collectively shown in Tables 1 and 2. In Tables 1 and 2, the reject rates in the nail penetration test, drop test, and vibration test are shown. In Tables 1 and 2, according to the battery voltage given for the nail penetration, Example 1 is shown as Examples 1-1 to 1-5, Example 2 is shown as Examples 2-1 to 2-5, Example 3 is shown as Examples 3-1 to 3-5, Comparative Example 1 is shown as Comparative Examples 1-1 to 1-5, Comparative Example 2 is shown as Comparative Examples 2-1 to 2-5, Comparative Example 3 is shown as Comparative Examples 3-1 to 3-5, and Comparative Example 4 is shown as Comparative Examples 4-1 to 4-5.

TABLE 1

| | Covering member | | Battery | Reject rate (%) | | | | |
|---|---|---|---|---|---|---|---|---|
| | | Thickness | voltage | Nail penetration test | | | | |
| | Structure | (μm) | (V) | Position 1A | Position 1B | Position 1C | Drop test | Vibration test |
| Ex. 1-1 | Aramid resin/ | 80/30/80 | 12.96 | 0 | 0 | 0 | 0 | 0 |
| Ex. 1-2 | Sn-plated Cu | | 13.11 | 0 | 0 | 0 | 0 | 0 |
| Ex. 1-3 | sheet/ | | 13.26 | 0 | 0 | 0 | 0 | 0 |
| Ex. 1-4 | Aramid resin | | 13.41 | 0 | 0 | 0 | 0 | 0 |
| Ex. 1-5 | | | 13.80 | 0 | 0 | 0 | 0 | 0 |
| Ex. 2-1 | Enamel resin/ | 80/30/80 | 12.96 | 0 | 0 | 0 | 0 | 0 |
| Ex. 2-2 | Sn-plated Cu | | 13.11 | 0 | 0 | 0 | 0 | 0 |
| Ex. 2-3 | sheet/ | | 13.26 | 0 | 0 | 0 | 0 | 0 |
| Ex. 2-4 | Enamel resin | | 13.41 | 0 | 0 | 0 | 0 | 0 |
| Ex. 2-5 | | | 13.80 | 0 | 0 | 0 | 0 | 0 |
| Ex. 3-1 | Fluoro-rubber/ | 80/30/80 | 12.96 | 0 | 0 | 0 | 0 | 0 |
| Ex. 3-2 | Sn-plated Cu | | 13.11 | 0 | 0 | 0 | 0 | 0 |
| Ex. 3-3 | sheet/ | | 13.26 | 0 | 0 | 0 | 0 | 0 |
| Ex. 3-4 | Fluoro-rubber | | 13.41 | 0 | 0 | 0 | 0 | 0 |
| Ex. 3-5 | | | 13.80 | 0 | 0 | 0 | 0 | 0 |

TABLE 2

| | Covering member | | Battery | Reject rate (%) | | | | |
|---|---|---|---|---|---|---|---|---|
| | | Thickness | voltage | Nail penetration test | | | | |
| | Structure | (μm) | (V) | Position 1A | Position 1B | Position 1C | Drop test | Vibration test |
| Comp. Ex. 1-1 | None | — | 12.96 | 20 | 30 | 40 | 0 | 0 |
| Comp. Ex. 1-2 | | | 13.11 | 70 | 80 | 90 | 0 | 0 |
| Comp. Ex. 1-3 | | | 13.26 | 100 | 100 | 100 | 0 | 0 |
| Comp. Ex. 1-4 | | | 13.41 | 100 | 100 | 100 | 0 | 0 |
| Comp. Ex. 1-5 | | | 13.80 | 100 | 100 | 100 | 0 | 0 |
| Comp. Ex. 2-1 | Only Sn-plated | 30 | 12.96 | 10 | 10 | 20 | 100 | 100 |
| Comp. Ex. 2-2 | Cu sheet | | 13.11 | 40 | 40 | 50 | 100 | 100 |
| Comp. Ex. 2-3 | | | 13.26 | 50 | 50 | 60 | 100 | 100 |
| Comp. Ex. 2-4 | | | 13.41 | 50 | 50 | 60 | 100 | 100 |
| Comp. Ex. 2-5 | | | 13.80 | 70 | 70 | 80 | 100 | 100 |
| Comp. Ex. 3-1 | Only Sn-plated | 100 | 12.96 | 0 | 0 | 0 | 100 | 100 |
| Comp. Ex. 3-2 | Cu sheet | | 13.11 | 0 | 0 | 0 | 100 | 100 |
| Comp. Ex. 3-3 | | | 13.26 | 0 | 0 | 0 | 100 | 100 |
| Comp. Ex. 3-4 | | | 13.41 | 0 | 0 | 0 | 100 | 100 |
| Comp. Ex. 3-5 | | | 13.80 | 0 | 0 | 0 | 100 | 100 |
| Comp. Ex. 4-1 | Aramid resin/ | 80/30 | 12.96 | 10 | 10 | 20 | 0 | 0 |
| Comp. Ex. 4-2 | Sn-plated Cu | | 13.11 | 40 | 40 | 50 | 0 | 0 |
| Comp. Ex. 4-3 | sheet | | 13.26 | 50 | 50 | 60 | 0 | 0 |
| Comp. Ex. 4-4 | | | 13.41 | 50 | 50 | 60 | 0 | 0 |
| Comp. Ex. 4-5 | | | 13.80 | 70 | 70 | 80 | 0 | 0 |

As can be seen from Tables 1 and 2, in each of Examples 1-1 to 1-5, Examples 2-1 to 2-5, and Examples 3-1 to 3-5, the reject rates in the all tests are 0, which indicates that satisfactory safety is achieved.

By contrast, in each of Comparative Examples 1-1 to 1-5, the reject rate in the nail penetration test was high. The reason for this is presumed that the conductive film was not provided outside of the battery casing and hence short-circuiting occurred inside the battery device to cause heat generation or ignition. Also in each of Comparative Examples 2-1 to 2-5, the reject rate in the nail penetration test was high. The reason for this is presumed as follows. The conductive film does not have a structure such that the conductive film is sandwiched between insulating films. Therefore, the conductive film detached from the nail at a point in time when short-circuiting occurred, and the short-circuiting between the conductive film and the battery casing caused short-circuiting inside the battery device before the electric energy of the battery device was satisfactorily consumed, leading to heat generation or ignition. As seen in Comparative Examples 3-1 to 3-5, when the conductive film 4 has a thickness as large as 100 μm, excellent results can be obtained in the nail penetration test, but such a large thickness of the conductive film increases the thickness of the covering members 3A, 3B, making it difficult to achieve a battery pack having a compact collective construction. In Comparative Examples 2-1 to 2-5 and 3-1 to 3-5, the all samples were rejected in the drop test and vibration test. The reason for this is presumed that the conductive film was not covered with a nonconductive film and had only the heat-shrinkable tube disposed between the conductive film and the battery casing, and the heat-shrinkable tube having poor mechanical strength was broken due to drop or vibration, causing the battery casing and the conductive film to be in contact. Further, in Comparative Examples 4-1 to 4-5, by virtue of the insulating film 5, excellent results were obtained in the drop test and vibration test, but the reject rates in the nail penetration test were as poor as those in Comparative Examples 2-1 to 2-5. The reason for this is presumed as follows. The Sn-plated Cu sheet as a conductive film has a structure such that only one side of the sheet is covered with the insulating film (the conductive film does not have a laminated structure such that the conductive film is sandwiched between insulating films). Therefore, heat generated during the short-circuiting caused the Sn-plated Cu sheet around the nail to be melted, so that the nail and the Sn-plated Cu sheet were likely to be in a non-contact state, causing ignition. With respect to the present Examples (Examples 1-1 to 1-5, Examples 2-1 to 2-5, and Examples 3-1 to 3-5), it is presumed that the conductive film has a structure such that the conductive film is sandwiched between insulating films which are in close contact with both sides of the conductive film and therefore, even when heat generated during the short-circuiting caused the conductive film around the nail to be melted, the conductive film around the nail did not detach from the nail, thus maintaining the contact between the conductive film and the nail.

With respect to each of the battery packs in Example 1 and Comparative Example 1, a soft nail test in which the batteries 1A to 1C were individually penetrated by a nail from the outside of the housing in a depth of 3 to 8 mm (depth from the outer surface of the battery casing 11) was performed, and a change of the state of the battery pack was observed to check the safety of the battery which had been damaged. Specifically, first, in an environment at 23° C., a cycle of a charge step, in which constant current charging was conducted at a current corresponding to 1.0 C until the voltage of the battery became 12.6 V and constant voltage charging was conducted at 12.6 V so that the total charging time became 3 hours, and a discharge step, in which discharging was conducted at a current corresponding to 1.0 C until the voltage of the battery became 9 V, was repeated three times. Then, the resultant batteries 1A to 1C were individually penetrated by a nail (Φ 2.5 mm) from the outside of the housing 7 so that the nail pierced the center of the battery casing 11, and, after 20 seconds, the appearance of each battery casing 11 was observed. A battery which caused smoking or ignition after the test was regarded as a reject, and a ratio of the reject(s) (reject rate) was determined. In each of the Examples and Comparative Examples, the number of samples (n) was 5. The nail penetration speed was 100 mm/sec. The results are shown in Table 3. In Table 3, according to the depth for the nail penetration, Example 1 is shown as Examples 1-6 to 1-11, and Comparative Example 1 is shown as Comparative Examples 1-6 to 1-11.

TABLE 3

| | Covering member | | Depth for nail | Reject rate (%) | | |
|---|---|---|---|---|---|---|
| | | Thickness | penetration | Nail penetration test | | |
| | Structure | (μm) | (mm) | Position 1A | Position 1B | Position 1C |
| Ex. 1-6 | Aramid resin/ | 80/30/80 | 3 | 0 | 0 | 0 |
| Ex. 1-7 | Sn-plated Cu sheet/ | | 4 | 0 | 0 | 0 |
| Ex. 1-8 | Aramid resin | | 5 | 0 | 0 | 0 |
| Ex. 1-9 | | | 6 | 0 | 0 | 0 |
| Ex. 1-10 | | | 7 | 0 | 0 | 0 |
| Ex. 1-11 | | | 8 | 0 | 0 | 0 |
| Comp. | None | — | 3 | 100 | 100 | 100 |
| Ex. 1-6 | | | | | | |
| Comp. | | | 4 | 100 | 100 | 100 |
| Ex. 1-7 | | | | | | |
| Comp. | | | 5 | 100 | 100 | 100 |
| Ex. 1-8 | | | | | | |
| Comp. | | | 6 | 100 | 100 | 100 |
| Ex. 1-9 | | | | | | |
| Comp. | | | 7 | 100 | 100 | 100 |
| Ex. 1-10 | | | | | | |
| Comp. | | | 8 | 100 | 100 | 100 |
| Ex. 1-11 | | | | | | |

As can be seen from Table 3, in Comparative Examples 1-6 to 1-11, all samples are rejected. By contrast, in each of Examples 1-6 to 1-11, the reject rate is 0, which indicates that satisfactory safety is achieved.

### Example 4

Next, the battery pack described above in the second embodiment was prepared. Lithium carbonate (Li₂CO₃) and cobalt carbonate (CoCO₃) were first mixed in an Li₂CO₃:CoCO₃ ratio of 0.5:1 (molar ratio), and calcined in air at 900° C. for 5 hours to obtain a lithium-cobalt composite oxide (LiCoO₂) as a cathode active material. Then, 91 parts by weight of the lithium-cobalt composite oxide obtained, 6 parts by weight of graphite as a conductor, and 3 parts by weight of polyvinylidene fluoride as a binder were mixed with one another to prepare a positive electrode composition. Subsequently, the positive electrode composition prepared was dispersed in N-methyl-2-pyrrolidone as a solvent to form a positive electrode composition slurry, and the resultant slurry was uniformly applied to both sides of a cathode current collector 41A made of an aluminum foil having a thickness of 15 μm and dried, and subjected to compression molding by means of a roll pressing machine to form a cathode active material layer 41B, thus preparing a positive electrode 41. Then, a positive electrode lead 44 made of aluminum was fitted to one end of the cathode current collector 41A. In this instance, in both ends of the positive electrode 41, a region where the cathode active material layer 41B was not formed, or active material layer-free region, was provided to expose the cathode current collector 41A, and the positive electrode lead 44 made of aluminum was fitted to the cathode current collector 41A present in part of the active material layer-free region and an insulating sheet 41C was put on the positive electrode so as to cover the cathode current collector 41A present in the remaining active material layer-free region.

Next, a negative electrode 42 was prepared as follows. Spherical artificial graphite particles having an average particle size of 25 μm, acetylene black, and polyvinylidene fluoride as a binder were first mixed in a 90:3:7 weight ratio to prepare a negative electrode composition. Then, the negative electrode composition prepared was dispersed in N-methyl-2-pyrrolidone as a solvent to form a negative electrode composition slurry, and the resultant slurry was selectively applied to both sides of an anode current collector 42A made of an electrolytic copper foil, followed by drying. The electrolytic copper foil used had a thickness of 15 μm and a surface roughness Ra of 0.3 μm. After drying, the resultant anode current collector was subjected to pressure molding by means of a roll pressing machine to form an anode active material layer 42B. Then, a negative electrode lead 45 made of nickel was fitted to one end of the anode current collector 42A uncovered with the anode active material layer 42B.

Subsequently, a separator 43 made of a microporous polypropylene film having a thickness of 20 μm was prepared, and the positive electrode 41, separator 43, negative electrode 42, and separator 43 were stacked in this order into a laminated structure, and then the resultant laminated structure was spirally wound many times, and shaped into a flat form to prepare a battery device 40.

The above-prepared battery device 40 was placed in a battery casing 31, and then an insulating plate 32 was disposed on the battery device 40, and the negative electrode lead 45 was welded to the battery casing 31 and the positive electrode lead 44 was welded to the lower end of a positive electrode pin 35 to fix a battery cap 33 to the open end of the battery casing 31. Then, an electrolytic solution was charged into the battery casing 31 from an inlet hole 39. The electrolytic solution was obtained by dissolving LiPF₆ as an electrolyte salt in a mixed solvent including 50% by volume of ethylene carbonate and 50% by volume of diethyl carbonate so that the salt concentration became 1 mol/dm³.

The electrolytic solution was charged into the battery casing 31, and then the inlet hole 39 was covered with a sealing member 39A to obtain a rectangular battery 10. The battery 10 has a capacity such that the discharge capacity became 800 mAh after constant current and constant voltage charging was conducted in an environment at 23° C. under conditions such that the upper limit voltage was 4.2 V and the current corresponded to 0.2 C and then constant current discharging was conducted under conditions such that the current corresponded to 0.2 C and the final voltage was 3.0 V.

The battery 10 was disposed between a pair of covering members 3A, 3B so that the covering members were in contact with the battery, and they were placed in a housing 7. Each of the covering members 3A, 3B had a structure having a conductive film 4 having a thickness of 30 μm, being made of a copper thin sheet covered with a tin plating film, and having both sides covered with insulating films 5, 6 made of an aramid resin (NOMEX®, manufactured and sold by Du Pont Co.) having a thickness of 80 μm. Finally, a predetermined step for fitting leads 8, 9 respectively to two openings 7K and the like were performed, obtaining a battery pack in Example 4.

### Comparative Example 5

A battery pack in Comparative Example 5 was prepared in substantially the same manner as in Example 4 except that no covering members 3A, 3B were provided.

With respect to each of the thus obtained battery packs in Example 4 and Comparative Example 5, a nail penetration test was performed in accordance with the procedure shown below, and a change of the state of the battery pack was observed to check the safety of the battery which had been damaged.

In the nail penetration test, first, in an environment at 23° C., constant current charging was conducted at a current corresponding to 0.2 C until the voltage of the battery became 4.2 V and then constant voltage charging was conducted at a voltage of 4.2 V so that the total charging time became 10 hours, and then discharging was conducted at a current corresponding to 0.2 C until the voltage became 3.0 V. Then, a cycle of a charge step, in which constant current charging was conducted at a current corresponding to 1.0 C until the voltage of the battery became 4.2 V and constant voltage charging was conducted at 4.2 V so that the total charging time became 3 hours, and a discharge step, in which discharging was conducted at a current corresponding to 1.0 C until the voltage of the battery became 9.0 V, was repeated three times. Then, constant current charging was conducted at a current corresponding to 0.2 C until the voltage of the battery became each value shown in Tables 4 and 5, and further constant voltage charging was conducted at that voltage so that the total charging time became 13 hours. The resultant battery 10 was penetrated by a nail (Φ 2.5 mm) from the outside of the housing 7 so that the nail pierced the center of the battery casing 31, and, after 20 seconds, the appearance of the battery 10 was observed. A battery which caused smoking or ignition after the test was regarded as a reject, and a ratio of the reject(s) (reject rate) was determined. In each of the Examples and Comparative Examples, the number of samples (n) was 10. The nail penetration speed was 100 mm/sec. The results are shown in Tables 4 and 5. In Tables 4 and 5, according to the battery voltage given for the nail penetration, Example 4 is shown as Examples 4-1 to 4-5, and Comparative Example 5 is shown as Comparative Examples 5-1 to 5-5.

TABLE 4

| | | | | | Nail |
|---|---|---|---|---|---|
| | | | | | penetra- |
| | | Covering member | | Battery | tion |
| | Anode active | | Thickness | voltage | test Reject |
| | material | Structure | (μm) | (V) | rate (%) |
| Ex. 4-1 | Artificial | Aramid resin/ | 80/30/80 | 4.32 | 0 |
| Ex. 4-2 | graphite | Sn-plated | | 4.37 | 0 |
| Ex. 4-3 | (Coating) | Cu sheet/ | | 4.42 | 0 |
| Ex. 4-4 | | Aramid resin | | 4.47 | 0 |
| Ex. 4-5 | | | | 4.60 | 0 |
| Ex. 5-1 | Silicon | Enamel resin/ | 80/30/80 | 4.32 | 0 |
| Ex. 5-2 | (Vapor | Sn-plated | | 4.37 | 0 |
| Ex. 5-3 | deposition) | Cu sheet/ | | 4.42 | 0 |
| Ex. 5.4 | | Enamel resin | | 4.47 | 0 |
| Ex. 5-5 | | | | 4.60 | 0 |
| Ex. 6-1 | Silicon | Fluororubber/ | 80/30/80 | 4.32 | 0 |
| Ex. 6-2 | (Sintering) | Sn-plated | | 4.37 | 0 |
| Ex. 6-3 | | Cu sheet/ | | 4.42 | 0 |
| Ex. 6-4 | | Fluororubber | | 4.47 | 0 |
| Ex. 6-5 | | | | 4.60 | 0 |

TABLE 5

| | | Covering member | | Battery | Nail penetration |
|---|---|---|---|---|---|
| | | | Thickness | voltage | test Reject rate |
| | Anode active material | Structure | (μm) | (V) | (%) |
| Comp. Ex. 5-1 | Artificial graphite | None | — | 4.32 | 30 |
| Comp. Ex. 5-2 | (Coating) | | | 4.37 | 90 |
| Comp. Ex. 5-3 | | | | 4.42 | 100 |
| Comp. Ex. 5-4 | | | | 4.47 | 100 |
| Comp. Ex. 5-5 | | | | 4.60 | 100 |
| Comp. Ex. 6-1 | Silicon | None | — | 4.32 | 90 |
| Comp. Ex. 6-2 | (Vapor deposition) | | | 4.37 | 100 |
| Comp. Ex. 6-3 | | | | 4.42 | 100 |
| Comp. Ex. 6-4 | | | | 4.47 | 100 |
| Comp. Ex. 6-5 | | | | 4.60 | 100 |
| Comp. Ex. 7-1 | Silicon | None | — | 4.32 | 80 |
| Comp. Ex. 7-2 | (Sintering) | | | 4.37 | 100 |
| Comp. Ex. 7-3 | | | | 4.42 | 100 |
| Comp. Ex. 7-4 | | | | 4.47 | 100 |
| Comp. Ex. 7-5 | | | | 4.60 | 100 |

### Example 5

A battery pack in Example 5 was prepared in substantially the same manner as in Example 4 except that the insulating films 5, 6 used in the covering members 3A, 3B were individually made of an enamel resin, and that the negative electrode 42 was prepared as shown below. The battery 10 had a capacity such that the discharge capacity became 1,000 mAh after constant current and constant voltage charging was conducted in an environment at 23° C. under conditions such that the upper limit voltage was 4.2 V and the current corresponded to 0.2 C and then constant current discharging was conducted under conditions such that the current corresponded to 0.2 C and the final voltage was 2.5 V.

The negative electrode 42 was prepared as follows. Specifically, a silicon thin film having a thickness of 7 μm was deposited using an electron beam deposition method on both sides of an anode current collector 41A made of an electrolytic copper foil, followed by heat treatment in an argon gas atmosphere at a temperature of 300° C. for 6 hours, to form an anode active material layer 42B. The electrolytic copper foil used had a thickness of 15 μm and a surface roughness Ra of 0.5 μm. Then, a negative electrode lead 45 made of nickel was fitted to one end of the anode current collector 42A. In this instance, the negative electrode lead 45 was pressure-welded to the anode current collector 42A by strongly pressing (caulking) the negative electrode lead against the current collector through the anode active material layer 42B.

### Comparative Example 6

A battery pack in Comparative Example 6 was prepared in substantially the same manner as in Example 5 except that no covering members 3A, 3B were provided.

With respect to each of the thus obtained battery packs in Example 5 and Comparative Example 6, a nail penetration test was performed in the same manner as in Example 4 and others, and a change of the state of the battery pack was observed to check the safety of the battery which had been damaged.

In the nail penetration test, first, in an environment at 23° C., constant current charging was conducted at a current corresponding to 0.2 C until the voltage of the battery became 4.2 V and then constant voltage charging was conducted at a voltage of 4.2 V so that the total charging time became 10 hours, and then discharging was conducted at a current corresponding to 0.2 C until the voltage became 2.5 V. Then, a cycle of a charge step, in which constant current charging was conducted at a current corresponding to 1.0 C until the voltage of the battery became 4.2 V and constant voltage charging was conducted at 4.2 V so that the total charging time became 3 hours, and a discharge step, in which discharging was conducted at a current corresponding to 1.0 C until the voltage of the battery became 3.0 V, was repeated three times. Then, constant current charging was conducted at a current corresponding to 0.2 C until the voltage of the battery became each value shown in Tables 4 and 5, and further constant voltage charging was conducted at that voltage so that the total charging time became 13 hours. The resultant battery 10 was penetrated by a nail (Φ 2.5 mm) from the outside of the housing 7 so that the nail pierced the center of the battery casing 31, and, after 20 seconds, the appearance of the battery 10 was observed. The results are shown in Tables 4 and 5, together with the results of Example 4.

### Example 6

A battery pack in Example 6 was prepared in substantially the same manner as in Example 5 except that the insulating films 5, 6 used in the covering members 3A, 3B were individually made of a fluororubber, and that the negative electrode 42 was prepared as shown below. The battery 10 had a capacity such that the discharge capacity became 1,000 mAh after constant current and constant voltage charging was conducted in an environment at 23° C. under conditions such that the upper limit voltage was 4.2 V and the current corresponded to 0.2 C and then constant current discharging was conducted under conditions such that the current corresponded to 0.2 C and the final voltage was 2.5 V.

The negative electrode 42 was formed in accordance with substantially the same procedure as in Example 5 except that the anode active material layer 42B was formed by a sintering method instead of an electron beam deposition method. Specifically, 90 parts by weight of silicon powder having an average particle size of 1 μm as an anode active material and 10 parts by weight of polyvinylidene fluoride as a binder were mixed with each other to prepare a negative electrode composition, and then the negative electrode composition prepared was dispersed in N-methyl-2-pyrrolidone to form a negative electrode composition slurry in a paste form. Then, an electrolytic copper foil having a thickness of 15 μm and having a surface roughness Ra of 0.5 μm was prepared as an anode current collector 42A, and the negative electrode composition slurry was uniformly applied to the surface of the electrolytic copper foil, and dried and then pressed, followed by heat treatment in a vacuum atmosphere at 400° C. for 12 hours, to form an anode active material layer 42B.

### Comparative Example 7

A battery pack in Comparative Example 7 was prepared in substantially the same manner as in Example 6 except that no covering members 3A, 3B were provided.

With respect to each of the thus obtained battery packs in Example 6 and Comparative Example 7, a nail penetration test was performed in the same manner as in Example 4 and others, and a change of the state of the battery pack was observed to check the safety of the battery which had been damaged. The conditions for the nail penetration test were the same as those used in Example 5. The results are shown in Tables 4 and 5, together with the results of Examples 4 and 5.

As can be seen from Tables 4 and 5, in each of Examples 4-1 to 4-5, 5-1 to 5-5, and 6-1 to 6-5, the reject rate is 0, which indicates that satisfactory safety is achieved.

By contrast, in each of Comparative Examples 5-1 to 5-5, 6-1 to 6-5, and 7-1 to 7-5, the reject rate in the nail penetration test was high. The reason for this is presumed that the conductive film was not provided outside the battery casing and hence short-circuiting occurred inside the battery device to cause heat generation or ignition.

The present Examples have confirmed that the battery pack of an embodiment has both compact construction and high safety such that excellent results are obtained in all the nail penetration test, drop test, and vibration test.

Hereinabove, the embodiments and Examples are described, but the present application is not limited to the above embodiments and Examples, and can be changed or modified. For example, in the above embodiments and Examples, a battery pack including a cylindrical or rectangular secondary battery having a battery device of a spirally wound structure is described, but the present application may be applied to a battery pack including a secondary battery having a stacked type battery device, and, in such a case, the battery pack can achieve both compact construction and high safety.

In the above embodiments and Examples, an example is described in which a pair of covering members are arranged opposite to each other through the battery, but the covering member is not limited to the two divided covering members, and there can be used, for example, a single covering member completely surrounding the battery without a gap along the outer surface of the battery casing. In such a case, for example, when a cylindrical covering member is provided along the outer surface of a cylindrical cell, a force is preferably applied to the covering member in the direction of the stacked device from all directions to the outer surface of the cell.

In the above embodiments and Examples, the battery using lithium as an electrode reaction substance is described, but the present application may be applied to a battery using another alkali metal, such as sodium or potassium, an alkaline earth metal, such as magnesium or calcium, or a light metal, such as aluminum. In this case, for example, the same anode active material as that used in the above embodiment can be used.

The battery casing and the covering member may either be in contact with each other or have another member disposed therebetween. Specifically, for example, as shown in FIG. 3, the outer surface of the battery casing 11 is covered with the heat-shrinkable tube 18, but the heat-shrinkable tube can be omitted or, instead, another member can be used.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A battery pack comprising:
a battery; and
a covering member;
wherein said battery includes
a battery device having a pair of electrodes opposite to each other, a separator disposed between said electrodes, wherein said electrodes and said separator are stacked into a laminated structure, and
a battery casing being electrically connected to one of said electrodes for containing said battery device therein, and
said covering member includes
a conductive film being electrically connected to another one of said electrodes for covering at least part of the outer surface of said battery casing, and
a pair of insulating films being arranged opposite to each other through said conductive film.

2. The battery pack according to claim 1, wherein said conductive film and the respective surfaces of said insulating films opposite to the conductive film are in close contact with each other.

3. The battery pack according to claim 1, wherein said conductive film is bonded with at least one of said insulating films.

4. The battery pack according to claim 2, wherein said conductive film is bonded with both of said insulating films.

5. The battery pack according to claim 1, wherein one of said insulating films is bonded with both of the outer surface of said battery casing and said conductive film.

6. The battery pack according to claim 1, wherein said electrodes are a positive electrode including a cathode active material layer formed on a cathode current collector and a negative electrode including an anode active material layer formed on an anode current collector,
wherein said cathode current collector has at least a surface, which is opposite to said anode active material layer, completely covered with said cathode active material layer or an insulating material.

7. A battery pack comprising:
a plurality of batteries connected to one another in series; and
a covering member;
wherein each of said batteries includes
a battery device having a positive electrode and a negative electrode opposite to each other, a separator disposed between said positive and negative electrodes, wherein said positive and negative electrodes and said separator are stacked into a laminated structure, and
a battery casing being electrically connected to said negative electrode for containing said battery device therein, and
said covering member includes
a conductive film being electrically connected to said positive electrode of said battery with the highest potential among said batteries for collectively covering at least part of the outer surfaces of said individual battery casings in said batteries, and
a pair of insulating films being arranged opposite to each other through said conductive film.

8. The battery pack according to claim 7, wherein said conductive film and the respective surfaces of said insulating films opposite to the conductive film are in close contact with each other.

9. The battery pack according to claim 7, further comprising a housing for containing said batteries and covering member therein and applying a force in the direction of the stacked conductive film and insulating films.

10. The battery pack according to claim 7, wherein said conductive film is bonded with at least one of said insulating films.

11. A battery pack comprising:
a plurality of batteries connected to one another in series;
a covering member; and
a housing;
wherein each of said batteries includes
a battery device having a positive electrode and a negative electrode opposite to each other, a separator disposed between said positive and negative electrodes, wherein said positive and negative electrodes and said separator are stacked into a laminated structure, and
a battery casing being electrically connected to said negative electrode for containing said battery device therein,
said covering member includes
a conductive film being electrically connected to said positive electrode of said battery with the highest potential among said batteries for collectively covering at least part of the outer surfaces of said individual battery casings in said batteries, and
an insulating film positioned closer to said battery casing than to said conductive film, wherein said conductive film and insulating film are stacked into a laminated structure, and
said housing contains said batteries and said covering member therein and applies a force in the direction of said stacked conductive film and insulating film.

12. The battery pack according to claim 11, wherein at least part of said conductive film is embedded in the sidewall of said housing.

13. The battery pack according to claim 11, wherein said conductive film is bonded with said insulating film.
